(19) United States
(12) Patent Application Publication
(10) Pub. No.: US 2008/0113285 A1
(43) Pub. Date: May 15, 2008

(54) IMAGE FORMING APPARATUS, IMAGE FORMING METHOD, AND PROCESS CARTRIDGE

(76) Inventors: Hideo Nakamori, Numazu-shi (JP); Akihiro Sugino, Numazu-shi (JP); Masanobu Gondoh, Ebina-shi (JP); Shinji Nohsho, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/873,876

(22) Filed: Oct. 17, 2007

(30) Foreign Application Priority Data
Nov. 10, 2006 (JP) 2006-305368

(51) Int. Cl. G03G 13/04; G03G 15/00

(52) U.S. Cl. 430/48; 399/159; 430/56

(57) ABSTRACT

The present invention provides an image forming apparatus that has high-durability and can prevent image degradation that could be caused by an increase in residual potential on a photoconductor, occurrence of image blur and incidental images and can stably form a high-quality image even when repetitively used for long hours, and includes at least an electrophotographic photoconductor, a non-contact type corona discharge charging unit, an exposing unit, a developing unit, a transfer unit and a charge eliminating unit configured to eliminate a residual charge on the photoconductor by irradiating the electrophotographic photoconductor with light, wherein the outermost surface layer of the electrophotographic photoconductor contains at least a filler and an is amine compound having a specific structure, and the exposure dose of the charge eliminating unit is controlled at at least two stages during a time from the start of image forming operation to the end of the image forming operation.

### CROSS-REFERENCE TO RELATED APPLICATIONS

The present patent application claims priority under 35 U.S.C. §119 from Japanese Patent Application No. 2006-305368, filed on Nov. 10, 2006 in the Japan Patent Office, the contents and disclosures of which are hereby incorporated by reference herein in their entirety.

### BACKGROUND OF THE INVENTION

1. Field of the Invention

The present invention relates to an image forming apparatus that has high-durability and allows for achieving high-quality image formation, and also relates to an image forming method using the image forming apparatus, and a process cartridge.

2. Description of the Related Art

Recent developments in information processing systems using an electrophotographic process are remarkable. In particular, laser printers and digital copiers that record information with a laser beam by converting information into digital signals have been remarkably improved in terms of their print quality and reliabilities. These laser printers and digital copiers have been combined with high-speed technologies. As a result, they have become used as laser printers and digital copiers capable of full-color printing. With the above-mentioned background, as required functions for an electrophotographic photoconductor (hereinafter, may be referred to as “photoconductor”), it is particularly important to satisfy both high-quality image formation and high-durability.

Typically, as photoconductors used for such laser printers and digital copiers and the like using an electrophotographic process, those using an organic photosensitive material are widely used because of the inexpensive costs, productivity, environmental safety and the like. These organic photoconductors (OPCs) are broadly classified into the following types; for example, (1) photoconductors using a photoconductive resin typified by polyvinyl carbazole (PVK); (2) photoconductors using a charge transporting complex typified by PVK-TNF (2,4,7-trinitrofluolenone); (3) pigment-dispersed type photoconductors using a pigment typified by a phthalocyanine-binder; and (4) function-separated photoconductors each formed with a combination of a charge generating layer containing a charge generating material and a charge transporting layer containing a charge transporting material.

Here, the mechanism of latent electrostatic image formation with the use of a function-separated photoconductor is that when the photoconductor is charged and then irradiated with light, the light passes through a charge transporting layer and is absorbed to a charge generating material in the charge generating layer to generate a charge, the generated charge is injected to the charge transporting layer from the boundary surface between the charge generating layer and the charge transporting layer and further moves in the charge transporting layer by effect of an electric field, and the charge on the photoconductor surface is neutralized, thereby forming a latent electrostatic image on the photoconductor surface.

However, an organic photoconductor (OPC) is easily exfoliated from its photosensitive layer in repetitive use. Acceleration of such exfoliation of a photosensitive layer easily causes a reduction in charge potential of the photoconductor, degradation of photosensitivity and further acceleration of background smear due to flaws and defects of the photoconductor surface, a reduction in image density and degradation in image quality. Providing frictional resistance to photoconductors has been a significant conventional issue to achieve. Further, in recent years, smaller diameter of photoconductors resulting from achieving higher-speed performance and down-sizing of image forming apparatuses leads imparting high-durability to photoconductors to a further more significant issue to achieve.

As a method of achieving a highly durable photoconductor, various methods have been widely known, for example, a protective layer is formed as the outermost surface of a photoconductor, and lubricating property is provided to the protective layer, the protective layer is hardened or a filler is added to the protective layer. In particular, the method of adding a filler to a protective layer is one of effective methods to make a photoconductor have high-durability. However, when a filler having high-electrical insulating properties is contained in the protective layer of a photoconductor, the electric resistance of the photoconductor will be high, and a remarkable increase in residual potential will be observed in the photoconductor. The increase in residual potential is largely affected by an increase in electric resistance and an increase in charge trapping sites which are caused by the filler contained in the protective layer. When a conductive filler is used for the protective layer, the electric resistance is reduced and the influence of an increase in residual potential is relatively small, however, image outlines will blur, in other words, a so-called image blur will occur, and the quality of images is heavily affected thereby.

It is difficult to use a filler having high-electrical insulating properties, and thus, conventionally, a filler having relatively low-electrical insulating properties, which has less influence of residual potential, has been used, and to prevent occurrence of image blur that could be caused by the filler, a unit equipped with a drum heater to heat the photoconductor has been used. By heating a photoconductor with a drum heater in this way, occurrence of image blur can be prevented, however, to mount a drum heater to a photoconductor, it is necessary to increase the diameter of the photoconductor. Thus, this method cannot be used for a photoconductor having a small diameter, which is becoming increasingly a trend, and for this reason, it has been difficult to achieve a photoconductor having a small diameter and high-durability. An image forming apparatus needs to be large in size in order to mount such a drum heater, which brings about various issues to solve, for example, electrical power consumption is remarkably increased, and it takes long time to start up such a large-size image forming apparatus.

An increase in residual potential which can be often seen when a filler having high-electrical insulating properties is used in a photoconductor leads to a high-electric potential at bright areas in the image forming apparatus, which further leads to a reduction in image density and a reduction in tone quality. To compensate for these reductions, it is necessary to increase the dark space electric potential, however, an increased dark space electric potential leads to a high-electric field intensity, which inconveniently causes not only image defects such as background smear but also causes a reduction in operating light of the photoconductor.

For this reason, as a method of preventing such a residual potential on a photoconductor from increasing, a method of forming a photoconductive layer as a protective layer has been proposed (see Japanese Patent Application Publication (JP-B) Nos. 44-834, 43-16198 and 49-10258). However, because the light intensity of light reaching a photosensitive layer is reduced by absorption of light to a protective layer, which leads to a problem that the photosensitivity is reduced, and the effect of preventing an increase in residual potential is little.

Further, a method has been proposed in which the average particle diameter of a metal or a metal oxide that is contained as a filler to a protective layer is set to 0.3 μm or less and the protective layer is substantially transparent to thereby prevent an accumulation of residual potential on the photoconductor (see Japanese Patent Application Laid-Open (JP-A) No. 57-30846). With the proposed method, the effect of preventing a residual potential from increasing is surely recognized, but the effect is still insufficient. The reason why the effect in preventing a residual potential is insufficient is that there is a high-possibility that the increased residual potential caused when the protective layer contains a filler is more attributable to charge traps due to presence of the filler and the dispersibility of the filler than to charge generating efficiency. Furthermore, the transparency of the protective layer can be increased by increasing the dispersibility of the filler, even when the average particle diameter of the filler is 0.3 μm or more, and when the filler significantly flocculates even with the average particle diameter thereof being 0.3 μm or less, the transparency of the layer will be reduced.

Further, a method has been proposed in which a charge transporting material is added along with a filler to a protective layer to thereby provide the protective layer with mechanical strength and to prevent an increase in residual potential on the photoconductor (see Japanese Patent Application Laid-Open (JP-A) No. 4-281461). The proposal of adding a charge transporting material to a protective layer is an effective method to exert an effect of improving the mobility of charge and to reduce a residual potential. However, when it is considered that a significant increase in residual potential caused by the filler contained in the protective layer is attributable to an increased electric resistance due to the presence of the filler or an increased charge trap sites, there is a limit in increasing the mobility of charge and preventing a residual potential from increasing. Accordingly, there is no choice but to reduce the thickness of the protective layer and to reduce the content of the filler. The proposed method has not yet achieved the level where it can satisfy the required durability.

As other methods to prevent a residual potential on a photoconductor from increasing, for example, the following methods have been proposed: (1) a method of adding Lewis acid etc. to a protective layer (see Japanese Patent Application Laid-Open (JP-A) No. 53-133444), (2) a method of adding an organic protonic acid to a protective layer (see Japanese Patent Application Laid-Open (JP-A) No. 55-157748), (3) a method of containing an electron-accepting material in a protective layer (see Japanese Patent Application Laid-Open (JP-A) No. 2-4275), and (4) a method of containing a wax having an acidic value of 5 mgKOH/g or less in a protective layer (see Japanese Patent Application Laid-Open (JP-A) No. 2000-66434). It can be considered that in these proposed methods, a charge can easily reach the surface of the photoconductor by improving the charge injection performance at the boundary surface between the protective layer and the charge transporting layer to form sites with low-electric resistance in the protective layer. With any of these proposed methods, an effect of reducing a residual potential is surely recognized, however, as a result, they have side-effects that image blur easily occurs and the influence on quality of images becomes conspicuous. When an organic acid is added to a protective layer of a photoconductor, it easily cause a reduction in dispersibility of a filler added therein, and thus the effect of reducing a residual potential is insufficient.

Further, when using an electrophotographic photoconductor containing a filler to obtain high-durability, in order to achieve high-quality image formation, it is important not only to prevent occurrence of image blur and prevent an increase in residual potential on the electrophotographic photoconductor but also to linearly transport a charge to the surface of the photoconductor without inhibiting the move of charge by the filler contained in the protective layer. Mobility of charge is largely affected by the dispersibility of the filler in the protective layer. With a condition where a filler flocculates, the mobility of charge is easily inhibited by the filler when the charge injected from a charge transporting layer to a protective layer moves to the surface of the photoconductor, as a result, dots formed with a toner are scattered, resulting in a large reduction in resolution. Further, when a protective layer is formed in an electrophotographic photoconductor, a writing light is scattered by a filler contained in the protective layer and the light transmittance is reduced by the filler, it also adversely affect the resolution. The influence on the light transmittance also closely relates to the dispersibility of the filler. Further, the dispersibility of a filler also largely affects the abrasion resistance, and in a condition where the filler flocculates considerably and the dispersibility is poor, the abrasion resistance of the photoconductor is largely reduced. Accordingly, when using an electrophotographic photoconductor in which a protective layer containing a filler is formed in order to obtain high-durability, to achieve high-quality image formation, it is important not only to prevent occurrence of image blur and an increase in residual potential but also to increase the dispersibility of the filler contained in the protective layer.

However, an effective means to solve all the above-noted problems has not yet been found so far. When a filler is contained in the outermost surface layer of a photoconductor for the purpose of obtaining high-durability, influences of image blur and increase in residual potential conspicuously appear, such problems that could be caused at the time of achieving high-quality image formation still remain. Also, to alleviate the influences, it is necessary to mount a drum heater to a photoconductor. Accordingly, it has not yet been achieved to provide a photoconductor having a small diameter and high-durability, which needs to have the most highest-durability, though, and the need to mount a drum heater to a photoconductor remains a major obstacle to down-sizing of an image forming apparatus and reducing electric power consumption.

Recently, a color image forming apparatus using a roller type charging unit, which has an electric power saving effect, exhibits less ozone generation and allows for compactness in size, has become mainly used. However, to obtain further higher-durability and higher-speed performance, a corona discharge type charging unit using a non-contact type electrode, which has been conventionally used, is reviewed. However, a corona discharge type charging unit exhibits much more amount of discharge products (ozone, NOx, etc.) generated by discharge electricity than a roller type charging unit, and when a photoconductor containing a filler in the outermost layer is used to obtain high-durability, image blur is likely to be caused.

When a corona discharge type charging unit is used to stabilize the charge potential of a photoconductor, a charge eliminating unit that eliminates a residual charge of a latent electrostatic image formed on the photoconductor with light is often used. The charge eliminating unit is used not only to stabilize a charge in the subsequent image forming process but also to prevent occurrence of incidental images in the subsequent process that could be caused by an influence of the latent electrostatic image formed in the previous image forming process. When such an image forming apparatus is used in combination with a photoconductor containing a filler in the outermost surface layer, an increase amount of residual potential tends to increase due to an influence of repeating a normal operation of charging-to-exposing and an influence of repetitively irradiating the photoconductor from a charge eliminating unit, and this has posed an impediment to keep the quality of images when the photoconductor is repeatedly used.

### BRIEF SUMMARY OF THE INVENTION

The present invention is proposed in view of the present situation and aims to solve the various conventional problems and to achieve the following objects. Specifically, the present invention aims to provide an image forming apparatus which has high-durability and is capable of preventing image degradation that could be caused by an increase in residual potential, occurrence of image blur and incidental images and is capable of stably forming a high-quality image even when repetitively used for long hours, and to provide an image forming method using the image forming apparatus and a process cartridge.

In view of the above-mentioned problems, the inventors of the present invention have studied and investigated countermeasures. To achieve acquisition of high-durability of an electrophotographic photoconductor, it is effective to add a filler to the outermost surface layer of the electrophotographic photoconductor, however, there is a problem that it causes image degradation such as an increase in residual potential on the electrophotographic photoconductor and occurrence of image blur. As a result of the investigation, the present inventors found that in an image forming apparatus which is equipped with a corona discharge type charging unit configured to discharge electricity in a non-contact manner, an electrophotographic photoconductor containing a filler in the outermost surface layer, and a charge eliminating unit configured to eliminate a residual charge of a latent electrostatic image formed on the electrophotographic photoconductor with light, accumulated energy of the charge eliminating light used to irradiate the electrophotographic photoconductor for long hours can be reduced and an increase in residual potential of the electrophotographic photoconductor can be reduced by controlling the charge eliminating exposure dose of the charge eliminating unit at least two stages.

Specifically, an increase in residual potential on an electrophotographic photoconductor, which is caused due to an influence of repetitive irradiation of the electrophotographic photoconductor with charge eliminating light, can be reduced by eliminating a residual charge on the electrophotographic photoconductor with a charge eliminating exposure dose B for a time length of at least one rotation or more of the electrophotographic photoconductor after the electrophotographic photoconductor has gone through an image formation process but just before the stoppage of rotation thereof, by setting a charge eliminating exposure dose A that is used to irradiate the electrophotographic photoconductor during image forming operation to a lower value than the charge eliminating exposure dose B and then irradiating the electrophotographic photoconductor in working condition with the charge eliminating exposure dose A.

However, the present inventors encountered a new problem that when a corona discharge type charging unit is used and a charge eliminating exposure dose is set to “weak”, an incidental image easily appear in the subsequent process. Then the present inventors further investigated the countermeasures. As a result, the inventors found that acidic gasses generated from a corona discharge type charging unit adhere or accumulate on the surface of an electrophotographic photoconductor and incidental images easily appear due to the adhered or accumulated acidic gasses, and also found that occurrence of incidental images, which are side effects of reducing a charge eliminating exposure dose when a corona discharge type charging unit is used, can be reduced by adding a compound represented by any one of General Formulas (1) and (2) enabling reducing occurrence of image blur, which is disclosed in Japanese Patent Application Laid-Open (JP-A) Nos. 2004-233955 and 2004-264788, to the outermost surface layer of the electrophotographic photoconductor in addition to the configuration stated above. Note that the effect of preventing occurrence of incidental images using an amine compound having a specific structure, which is represented by any one of the General Formulas (1) and (2), is an obtained result, the details of the reason why occurrence of incidental images can be prevented have not yet been clarified. However, it is presumed that a substituted amino group contained in the structure of the amine compound controls generation of an effective radical material to acidic gasses, and this is contributory to the prevention of occurrence of incidental images.

The present invention is based on the findings of the present inventors. The means for solving aforesaid problems are as follows.
<1> An image forming apparatus which has at least an electrophotographic photoconductor, a corona discharge type charging unit configured to charge the surface of the electrophotographic photoconductor in a non-contact manner, an exposing unit configured to expose the charged electrophotographic photoconductor surface to form a latent electrostatic image, a developing unit configured to develop the latent electrostatic image using a toner to form a visible image, a transfer unit configured to transfer the visible image onto a recording medium, and a charge eliminating unit configured to eliminate a residual charge on the electrophotographic photoconductor by irradiating the electrophotographic photoconductor with light, wherein the outermost surface layer of the electrophotographic photoconductor contains at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation,

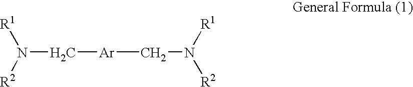

where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group,

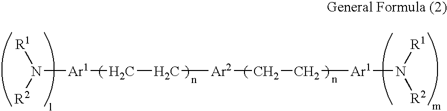

where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.
<2> The image forming apparatus according to the item <1>, wherein a charge eliminating exposure dose A of the charge eliminating unit used to irradiate the electrophotographic photoconductor during image forming operation is set to a lower value than a charge eliminating exposure dose B of the charge eliminating unit that is used to irradiate the electrophotographic photoconductor for a time length of at least one rotation or more of the electrophotographic photoconductor just before the stoppage of rotation thereof.
<3> The image forming apparatus according to the item <2>, wherein the charge eliminating exposure dose A is ¼ to ⅔ of the charge eliminating exposure dose B.
<4> The image forming apparatus according to the item <1>, wherein the filler contains at least one selected from metal oxides.
<5> The image forming apparatus according to the item <1>, wherein the filler has an average primary particle diameter of 0.01 μm to 1.0 μm.
<6> The image forming apparatus according to the item <1>, wherein the content of the filler in the outermost surface layer of the electrophotographic photoconductor is 5% by mass to 50% by mass.
<7>The image forming apparatus according to the item <1>, wherein the outermost surface layer of the electrophotographic photoconductor contains an organic compound having an acidic value of 10 mgKOH/g to 700 mgKOH/g.
<8> The image forming apparatus according to the item <1>, wherein the electrophotographic photoconductor contains a substrate, a photosensitive layer and a protective layer formed in this order on the substrate, and the protective layer constitutes the outermost surface layer.
<9> The image forming apparatus according to the item <1>, wherein the exposing unit is any one of a laser diode (LD) and a light-emitting diode (LED), and a latent electrostatic image is digitally written on the electrophotographic photoconductor using the exposing unit.
<10> The image forming apparatus according to the item <1>, wherein visual images in a plurality of colors are sequentially superimposed on the electrophotographic photoconductor to form a color image.
<11> The image forming apparatus according to the item <1>, having a plurality of electrophotographic photoconductors, wherein monochrome visual images developed on the respective electrophotographic photoconductors are sequentially superimposed to form a color image.
<12> The image forming apparatus according to the item <1>, further having an intermediate transfer unit configured to primarily transfer a visual image developed on the electrophotographic photoconductor to an intermediate transfer member and then secondarily transfer the visual image on the intermediate transfer member onto a recording medium, wherein visual images in a plurality of colors are sequentially superimposed on the intermediate transfer member to form a color image, and the color image is secondarily transferred onto the recording medium at a time.
<13> An image forming method which includes at least charging the surface of an electrophotographic photoconductor with a corona discharge type charging unit in a non-contact manner, exposing the charged electrophotographic photoconductor surface to form a latent electrostatic image, developing the latent electrostatic image using a toner to form a visible image, transferring the visible image onto a recording medium, and eliminating a residual charge on the electrophotographic photoconductor by irradiating the electrophotographic photoconductor with light, wherein the outermost surface layer of the electrophotographic photoconductor contains at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation,

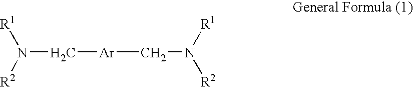

where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group,

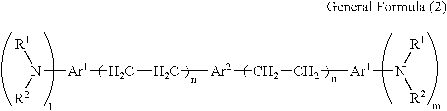

where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.
<14> A process cartridge which has an electrophotographic photoconductor, and at least one selected from a charging unit, an exposing unit, a developing unit, a transfer unit, a cleaning unit and a charge eliminating unit, wherein the process cartridge is detachably mounted to the main body of an image forming apparatus, wherein the image forming apparatus has the electrophotographic photoconductor, the corona discharge type charging unit configured to charge the surface of the electrophotographic photoconductor in a non-contact manner, the exposing unit configured to expose the charged electrophotographic photoconductor surface to form a latent electrostatic image, the developing unit configured to develop the latent electrostatic image using a toner to form a visible image, the transfer unit configured to transfer the visible image onto a recording medium, and a charge eliminating unit configured to eliminate a residual charge on the electrophotographic photoconductor by irradiating the electrophotographic photoconductor with light, wherein the outermost surface layer of the electrophotographic photoconductor contains at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation,

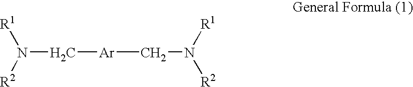

where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group,

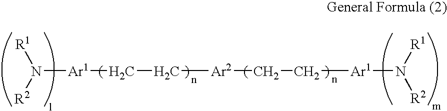

where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.

The present invention can solve the above-mentioned various conventional problems and can provide an image forming apparatus which has high-durability and is capable of preventing image degradation that could be caused by an increase in residual potential on an electrophotographic photoconductor, occurrence of image blur and incidental images and is capable of stably forming a high-quality image even when repetitively used for long hours, and can provide an image forming method using the image forming apparatus and a process cartridge.

Since the image forming apparatus of the present invention respectively have high-durability and is capable of preventing image degradation that could be caused by an increase in residual potential on a photoconductor, occurrence of image blur and incidental images and is capable of stably forming a high-quality image even when repetitively used for long hours, the image forming apparatus can be preferably used for electrophotographic laser printers, electrophotographic digital copiers, electrophotographic full-color copiers and electrophotographic full-color laser printers.

### BRIEF DESCRIPTION OF THE SEVERAL VIEWS OF THE DRAWINGS

FIG. 1 is a cross-sectional view schematically showing one example of a single-layered electrophotographic photoconductor of the present invention.

FIG. 2 is a cross-sectional view schematically showing one example of a multi-layered electrophotographic photoconductor of the present invention.

FIG. 3 is a cross-sectional view schematically showing another example of a single-layered electrophotographic photoconductor of the present invention.

FIG. 4 is a cross-sectional view schematically showing another example of a multi-layered electrophotographic photoconductor of the present invention.

FIG. 5 is a cross-sectional view schematically showing still another example of a multi-layered electrophotographic photoconductor of the present invention.

FIG. 6 is a schematic view showing one example of an image forming apparatus of the present invention.

FIG. 7 is a schematic view showing another example of an image forming apparatus of the present invention.

FIG. 8 is a schematic view showing still another example of an image forming apparatus of the present invention.

FIG. 9 is a schematic view showing one example of a tandem-type image forming apparatus of the present invention.

FIG. 10 is a schematic view showing one example of a process cartridge of the present invention.

### DETAILED DESCRIPTION OF THE INVENTION

### (Image Forming Apparatus and Image Forming Method)

The image forming apparatus of the present invention is equipped with at least an electrophotographic photoconductor, a charging unit, an exposing unit, a developing unit, a transfer unit and a charge eliminating unit and is further equipped with other units suitably selected in accordance with necessity, for example, a fixing unit, a cleaning unit, a recycling unit and a controlling unit.

The image forming method of the present invention includes at least a charging step, an exposing step, a developing step, a transferring step and a charge eliminating step and further includes other steps suitably selected in accordance with necessity, for example, a fixing step, a cleaning step, a recycling step and a controlling step.

The image forming method of the present invention can be favorably carried out by using the image forming apparatus of the present invention, the charging step can be carried out by using the charging unit, the exposing step can be carried out by using the exposing unit, the developing step can be carried out by using the developing unit, the transferring step can be carried out by using the transfer unit, the charge eliminating step can be carried out by using the charge eliminating unit, and the other steps can be carried out by using the other units.

### <Electrophotographic Photoconductor>

The electrophotographic photoconductor is not particularly limited as to the layer configuration and any layer configuration can be selected in accordance with the intended use. A first embodiment of the electrophotographic photoconductor of the present invention has a photosensitive layer that is formed in a single-layer (hereinafter, may be referred to as “single-layered photosensitive layer”), on a substrate and further has other layers such as a protective layer, an undercoat layer in accordance with necessity. Further, a second embodiment of the electrophotographic photoconductor has a substrate, a photosensitive layer in which a charge generating layer and a charge transporting layer are multi-layered on the substrate (hereinafter, may be referred to as “multi-layered photosensitive layer”) and further has other layers such as a protective layer and an undercoat layer in accordance with necessity. In the second embodiment of the present invention, charge generating layer and the charge transporting layer may be formed in a reverse order.

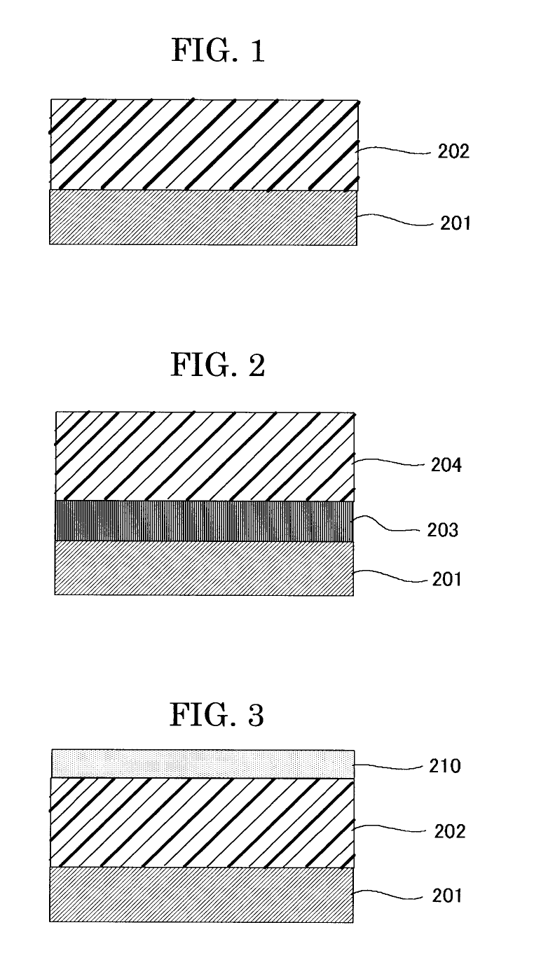

Here, the electrophotographic photoconductor of the present invention will be explained with reference to drawings. FIGS. 1 to 5 are respectively a cross-sectional view schematically showing one example of the electrophotographic photoconductor of the present invention. The electrophotographic photoconductor shown in FIG. 1 has a substrate 201 and a photosensitive layer 202 containing a charge generating material and a charge transporting material on a substrate 201, and a filler, and the photosensitive layer 202 contains a compound represented by any one of General Formulas (1) and (2).

In an electrophotographic photoconductor shown in FIG. 2, a charge generating layer 203 containing a charge generating material and a charge transporting layer 204 containing a charge transporting material are multi-layered on a substrate 201, and the charge transporting layer 204 contains a filler and a compound represented by any one of General Formulas (1) and (2).

An electrophotographic photoconductor shown in FIG. 3 has a substrate 201 and a photosensitive layer 202 containing a charge generating material and a charge transporting material on the substrate 201 and further has a protective layer 210 on the surface of the photosensitive layer 202, and the protective layer 210 contains a filler and a compound represented by any one of General Formulas (1) and (2).

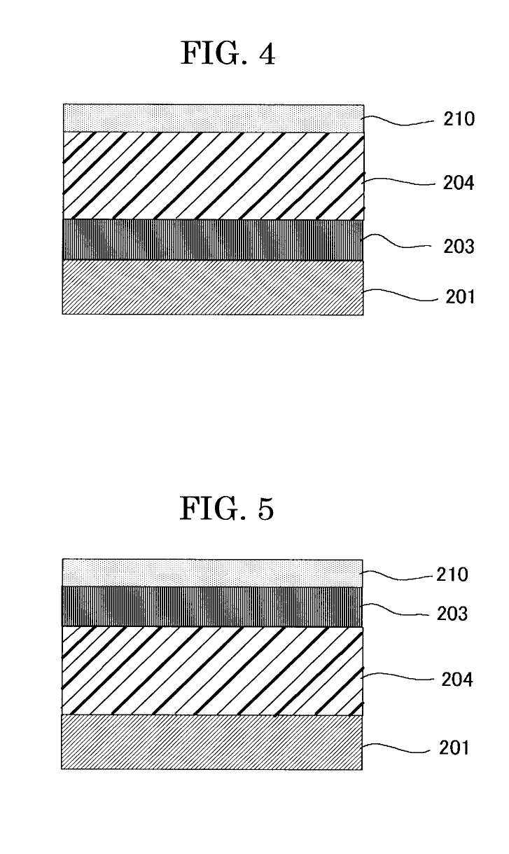

In an electrophotographic photoconductor shown in FIG. 4, a charge generating layer 203 containing a charge generating material and a charge transporting layer 204 containing a charge transporting material are multi-layered on a substrate 201, a protective layer 210 is further formed on the surface of the charge transporting layer 204, and the protective layer 210 contains a filler and a compound represented by any one of General Formulas (1) and (2).

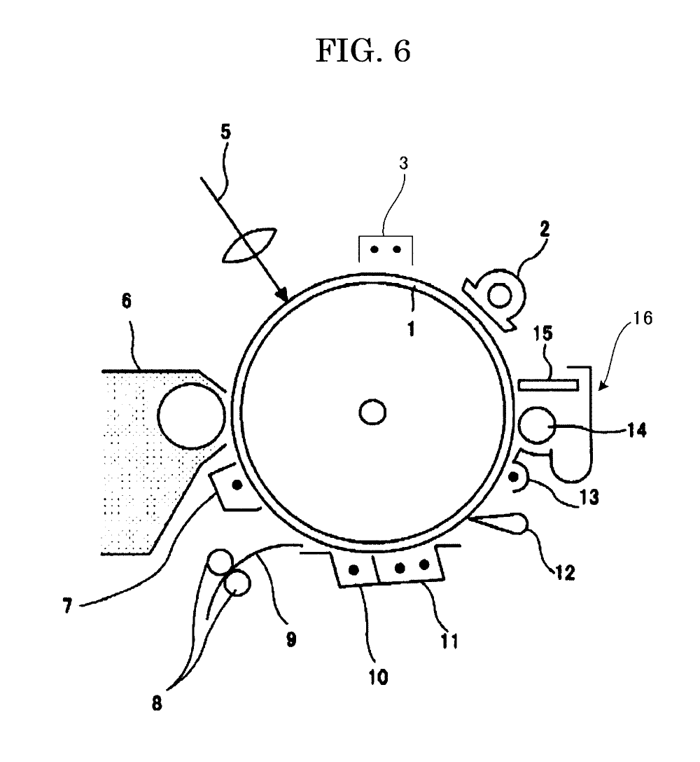

In an electrophotographic photoconductor shown in FIG. 5, a charge transporting layer 204 containing a charge transporting material and a charge generating layer 203 containing a charge generating material are multi-layered on a substrate 201, a protective layer 210 is further formed on the surface of the charge generating layer 203, and the protective layer 210 contains a filler and a compound represented by any one of General Formulas (1) and (2).

For the outermost surface layer, in the multi-layered photoconductor, for example, a charge transporting layer or a protective layer is exemplified. In the single-layered photoconductor, for example, a photosensitive layer or a protective layer is preferably exemplified for the outermost surface layer. Of these, an embodiment of an electrophotographic photoconductor is particularly preferable in which the electrophotographic photoconductor has a substrate, a charge generating layer, a charge transporting layer and a protective layer being formed in this order on the substrate, and the protective layer constitutes the outermost surface layer.

The outermost surface layer of the electrophotographic photoconductor contains at least a filler and a compound represented by any one of the following General Formulas (1) and (2) and further contains other components in accordance with necessity.

### —Filler—

For the filler, any one of an organic filler and an inorganic filler is used. Examples of the organic filler include fluorine resin powders composed of such as polytetrafluoroethylene; silicone resin powders and a-carbon powders. Examples of the inorganic filler include metal powders composed of such as copper, tin, aluminum and indium; metal oxides such as silica, tin oxide, zinc oxide, titanium oxide, alumina, zirconium oxide, indium oxide, antimony oxide, bismuth oxide, calcium oxide, tin oxide doped with antimony, and indium oxide doped with tin; metal fluorides such as tin fluoride, calcium fluoride and aluminum fluoride; potassium titanates and boron nitrides. Of these, it is advantageous to use an organic filler in terms of hardness of a used filler for the purpose of improving abrasion resistance of the photoconductor.

Further, as a filler, hardly causing so-called image blur, a filler having high electrical insulating property is preferable. For such a filler, a filler having a pH of 5 or more or a filler having a dielectric constant of 5 or more is particularly effective, and examples thereof include titanium oxides, aluminas, zinc oxides and zirconium oxides. A filler having a pH of 5 or more or a filler having a dielectric constant of 5 or more may be used singularly. Tow or more fillers each having a pH of 5 or less and each having a pH of 5 or more may be mixed for use, or two or more fillers each having a dielectric constant of 5 or less and each having a dielectric constant of 5 or more may be mixed for use. Of these fillers, an α-alumina, which has high-electrical insulating property and is highly thermally stable and has a hexagonal close-packed structure, is particularly useful in terms of preventing occurrence of image blur and abrasion resistance.

The filler is preferably subjected to a surface treatment using at least one surface finishing agent, because when the dispersibility of the filler is lowered, it causes not only an increase in residual potential on the electrophotographic photoconductor but also a reduction in transparency of the outermost surface layer and occurrence of coating defects and further causes a reduction in abrasion resistance.

The surface finishing agent is not particularly limited an may be suitably selected from among conventionally used surface finishing agents, however, a surface finishing agent capable of maintaining the electrical insulating property of the filler is preferable. Examples of such a surface finishing agent include titanate coupling agents, aluminum coupling agents, zircoaluminate coupling agents, higher fatty acids, or compounds prepared with mixtures thereof and silane coupling agent(s); Al₂O₃, TiO₂, ZrO₂, silicone, aluminum stearate or mixtures thereof are more preferable in terms of dispersibility of the filler and preventing occurrence of image blur. An influence of image blur is increased by the surface treatment with the use of the silane coupling agent, however, the influence may be suppressed by mixing the surface finishing agent with a silane coupling agent for use. The use amount of the surface finishing agent varies depending on the average primary particle diameter of the filler used, however, it is preferably 3% by mass to 30% by mass and more preferably 5% by mass to 20% by mass. When the use amount of the surface finishing agent is less than 3% by mass, the dispersion effect of the filler cannot be obtained, and when more than 30% by mass, it may cause an excessive increase in residual potential on the electrophotographic photoconductor.

The average primary diameter of the filler is preferably 0.01 μm to 1.0 μm, and more preferably 0.05 μm to 0.8 μm. When the average particle diameter of the filler is less than 0.01 μm, it may cause a reduction in abrasion resistance, a reduction in dispersibility and the like, and when more than 1.0 μm, sedimentation property of the filler may be accelerated, and toner filming may occur.

The average particle diameter of the filler can be measured, for example, by visually observing the filler under an electron microscope.

The content of the filler in the outermost surface layer is preferably 5% by mass to 50% by mass, and more preferably 10% by mass to 40% by mass. When the content of the filler is less than 5% by mass, the abrasion resistance of the photoconductor is insufficient, and when more than 50% by mass, the transparency of the outermost surface layer may be impaired. When a filler is added to the photosensitive layer surface, the filler can be contained in the entire photosensitive layer. However, in this case, it is preferable that a concentration gradient of the filler is provided so that the outermost surface constituted by the charge transporting layer has the highest concentration and the photosensitive layer at the substrate side has the lowest concentration, or the charge transporting layer is multi-layered and the filler concentration is gradually increased from the substrate side toward the surface side of the photosensitive layer.

### —Organic Compound Having Acidic Value of 10 mgKOH/g to 700 mgKOH/g—

In the electrophotographic photoconductor, the outermost surface layer containing a filler allows for achieving high-durability and avoiding occurrence of image blur, however, the residual potential is increased and the influence has increasingly impact on formation of an image. To suppress the increase in residual potential, it is preferable to add an organic compound having an acidic value of 10 mgKOH/g to 700 mgKOH/g.

Here, the acidic value is defined by a milligram of a potassium hydrate required to neutralize a free fatty acid contained in 1 gram of a sample and can be measured by the method specified by JIS K2501.

The organic compound having an acidic value of 10 mgKOH/g to 700 mgKOH/g is not particularly limited, and examples thereof include organic fatty acids and resins each having an acidic value of 10 mgKOH/g to 700 mgKOH/g. However, organic acids such as maleic acid, citric acid, tartaric acid and succinic acid each of which has an extremely low molecular weight and acceptors may drastically reduce the dispersibility of the filler. Thus, with use of the above-mentioned organic fatty acids, the reducing effect of the residual potential may not be sufficiently exerted. Thus, in order to reduce the residual potential of a photoconductor and increase the dispersibility of the filler, it is preferable to use a low-molecular weight polymer, resin and copolymer, and further, to mix them for use. For the structure of the organic compound, the organic compound more preferably has a linear structure with less steric hindrance. To enhance dispersibility of the filler, it is necessary to impart affinity to both the filler and a binder resin used. When a material having large steric hindrance is used, the affinity between the filler and the binder resin is lowered, which leads to occurrence of the various problems mentioned above.

From the above-noted viewpoints, for the organic compound having an acidic value of 10 mgKOH/g to 700 mgKOH/g, a polycarboxylic acid is preferably used. The polycarboxylic acid is a compound having a structure in which a polymer or a copolymer contains a carboxylic acid. All the organic compounds containing a carboxylic acid or derivatives thereof such as polyester resins, acrylic resins, and copolymers using polyester resins, acrylic resins, and styrene acrylic-copolymers can be used. Each of these organic compounds may be used alone or in combination with two or more. As the case may be, the dispersibility of the filler may be improved by mixing each of these materials and an organic fatty acid(s) for use, or the reducing effect of the residual potential may be increased because of the improved dispersibility of the filler.

The organic compound preferably has an acidic value of 10 mgKOH/g to 700 mgKOH/g and more preferably has an acidic value of 30 mgKOH/g to 400 mgKOH/g. When the acidic value is excessively high, the electric resistivity is excessively reduced, resulting in a large influence of image blur, and when the acidic value is excessively low, the additive amount of the organic compound needs to be increased, and the reducing effect of a residual potential will be insufficient. It is necessary for the acidic value of the organic compound having an acidic value of 10 mgKOH/g to 700 mgKOH/g be determined depending on the additive amount thereof and the composition balance. The use of an organic compound having a higher acidic value necessarily in the same additive amount does not necessarily lead to a higher reducing effect of residual potential. The reducing effect of residual potential is greatly relating to the adsorption property of the organic compound having an acidic value of 10 mgKOH/g to 700 mgKOH/g to the filler.

The content of the organic compound having an acidic value of 10 mgKOH/g to 700 mgKOH/g is determined depending on the acidic value and the content of the filler. Specifically, when the content of the organic compound having an acidic value of 10 mgKOH/g to 700 mgKOH/g is represented by A, the acidic value of the organic compound having an acidic value of 10 mgKOH/g to 700 mgKOH/g is represented by B, and the content of the filler is represented by C, it is preferable that the following Relational Expression 1 is satisfied.

0.2≦acidic value equivalent (A×B/C)≦20 Relational Expression 1

When the content of the organic compound having an acidic value of 10 mgKOH/g to 700 mgKOH/g is excessively high, this has the opposite effect and may cause a dispersion defect and an influence of image blur greatly appears. In contrast, when the content is excessively low, it may cause a dispersion defect and the reducing effect of residual potential may be insufficient.

The filler can be dispersed along with at least an organic solvent and an organic compound having an acidic value of 10 mgKOH/g to 700 mgKOH/g using a ball mill, an attritor, a sand mill, an ultrasonic wave or the like. Of these dispersing devices, it is more preferable to use a ball mill from the perspective that it allows for increasing the contact efficiency between the filler and the organic compound having an acidic value of 10 mgKOH/g to 700 mgKOH/g and causes less amount of impurities mixed from the outside. For a material of a dispersing medium used, all the conventional materials used for media such as zirconia, alumina and agate can be used, however, alumina is particularly preferable in terms of dispersibility of the filler and the reducing effect of residual potential. The use of zirconia causes a large amount of abrasion of the dispersing medium in the dispersion treatment, and the residual potential is significantly increased by the impurities. Further, the dispersibility of the filler is greatly reduced by the impurities of the abrasion powder and then the sedimentation property of the filler is accelerated. When alumina is used for the dispersing medium, the abrasion amount of the dispersing medium can be kept low and the influence of the entered abrasion powder on the residual potential is extremely small, although the dispersing medium slightly abrades away in the dispersion treatment. Further, even when the abrasion powder gets mixed, it exerts less adverse influence on the dispersibility of the filler. Thus, it is particularly preferable to use alumina for material of the dispersing medium used in the dispersion treatment.

It is preferable that the organic compound having an acidic value of 10 mgKOH/g to 700 mgKOH/g is preliminarily added along with the filler and an organic solvent in a coating solution for the outermost surface layer before the dispersion treatment, because it can prevent the filler from flocculating in the coating solution and can suppress the sedimentation property of the filler. In the meanwhile, a binder resin and a charge transporting material can be added to the coating solution before the dispersion treatment, however, in this case, a slight reduction in dispersibility of the filler may be observed. For this reason, the binder resin and the charge transporting material are preferably added in a state of being dissolved in an organic solvent to the dispersed coating solution after the dispersion treatment of the filler.

In the organic compound, ozone generated by a corona discharge type charging unit and acidic gases such as NOx easily adsorb thereto, which is derived from the chemical structure thereof. As the case may be, the adsorption of ozone and acidic gases may cause a low-electric resistance of the outermost surface layer and problems with image deletion and the like.

In the present invention, to solve this problem, the outermost surface layer contains a compound represented by any one of the following Structural Formulas (1) and (2).

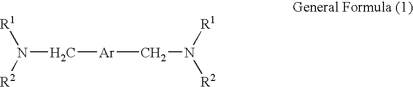

In General Formula (1), R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group.

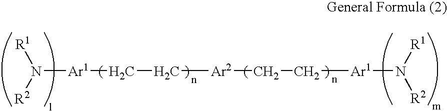

In General Formula (2), R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of 0 (zero) at the same time; and “n” is an integer of 1 or 2.

Examples of the alkyl group in General Formula (1) or General Formula (2) include methyl group, ethyl group, propyl group, isopropyl group, butyl group, isobutyl group, sec-butyl group, tertiary 5.02 t-butyl group, pentyl group, isopentyl group, neopentyl group, hexyl group, heptyl group, octyl group, nonyl group, decyl group, undecyl group, undecanyl group, dodecyl group, vinyl group, benzyl group, phenethyl group, styryl group, cyclopentyl group, cyclohexyl group, cycloheptyl group and cyclohexenyl group.

Examples of the aryl group in General Formula (1) or General Formula (2) include phenyl group, tolyl group, xylyl group, styryl group, naphthyl group, anthryl group and biphenyl group.

Examples of the aromatic hydrocarbon group in General Formula (1) or General Formula (2) include aromatic ring groups such as benzene, biphenyl, naphthalene, anthracene, fluorene and pyrene; and aromatic heterocyclic groups such as pyridine, quinoline, thiophene, furan, oxazole, oxadiazole and carbazole.

When R¹ and R² are combined to form a heterocyclic group containing a nitrogen atom, for the heterocyclic group, condensed heterocyclic groups in each of which an aromatic hydrocarbon group is condensed in a pyrrolidino group, a piperidino group, a piperazino group etc. are exemplified.

Examples of the substituent groups thereof include the specific examples of the alkyl group mentioned above, alkoxy groups such as methoxy group, ethoxy group, propoxy group and buthoxy group; halogen atoms such as fluorine atom, chlorine atom, bromine atom and iodine atom; the above-mentioned aromatic hydrocarbon groups; and heterocyclic groups such as pyrrolidine, piperidine and piperazine.

A diamine compound represented by any one of General Formulas (1) and (2) can be easily produced by the method described in “E. Elce and A. S. Hay, Polymer, Vol. 37 No. 9, 1745 (1996)). Specifically, the diamine compound can be produced by reacting a dihalogen compound represented by the following General Formula (a) with a secondary amine compound represented by the following General Formula (b) in the presence of a basic compound at a temperature ranging from room temperature to 100° C.

XH₂C—Ar—CH₂X General Formula (a)

In General Formula (a), Ar represents the same one as represented by General Formula (1), and X represents a halogen atom.

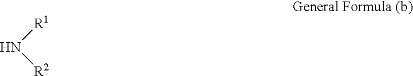

In General Formula (b), R¹ and R² respectively represent the same one as represented by General Formula (1).

The basic compound is not particularly limited and may be suitably selected in accordance with the intended use. Examples of the basic compound include potassium carbonates, sodium carbonates, potassium hydroxides, sodium hydroxides, sodium hydrides, sodium methylates, and potassium-t-buthoxy compounds. The reaction solvent is not particularly limited and may be suitably selected in accordance with the intended use. Examples thereof include dioxane, tetrahydrofuran, toluene, xylene, dimethylsulfoxide, N,N-dimethylformamide, N-methylpyrrolidone, 1,3-dimethyl-2-imidazolidinone and acetonitrile.

Hereinafter, specific examples of the compound represented by any one of General Formulas (1) and (2) will be described. However, the compound is not limited to the following specific examples.

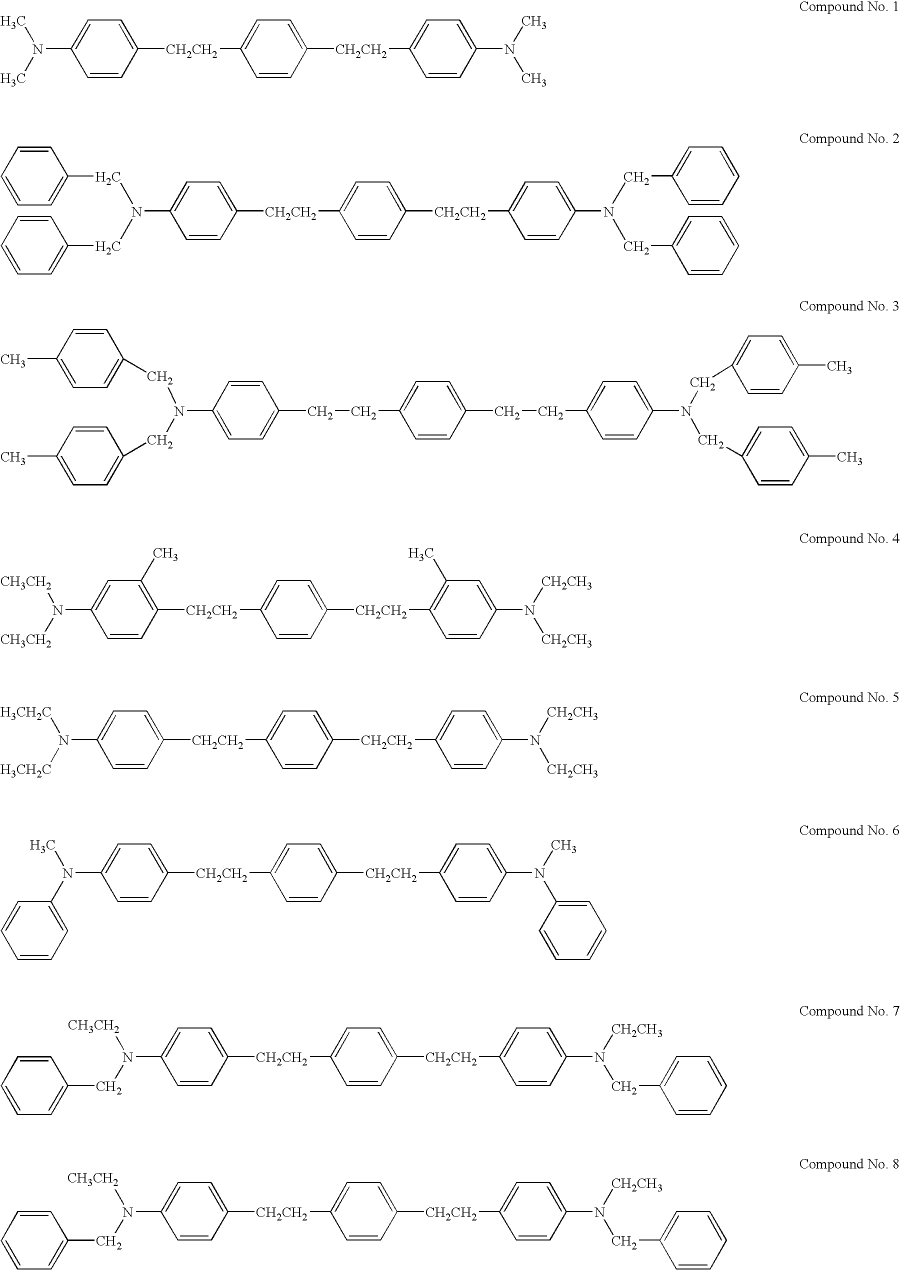

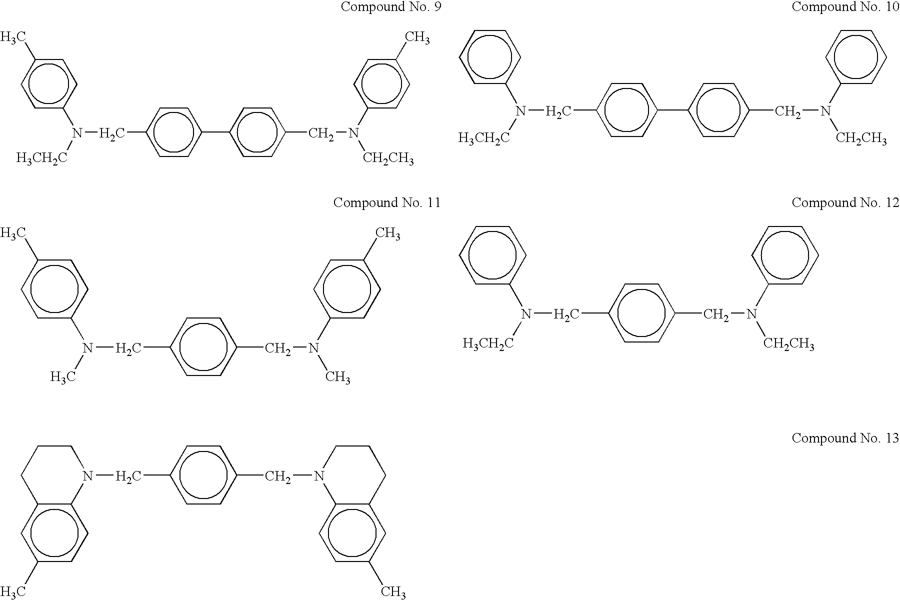

The content of the compound represented by any one of General Formulas (1) and (2) in the outermost surface layer is preferably 1% by mass to 60% by mass, and more preferably 2% by mass to 50% by mass.

When storage stability for the coating solution for the outermost surface layer is required, in which the compound represented by any one of General Formulas (1) and (2) is used in combination with an organic compound having an acidic value of 10 mgKOH/g to 700 mgKOH/g, it is preferable to add a specific antioxidant to the coating solution in order to inhibit generation of salts by the cross-interaction thereof. The generation of salts may cause not only discoloration of the coating solution but also cause problems with increases in residual potential etc. in the electrop hotographic photoconductor produced.

For antioxidants that can be used in the present invention, typical antioxidants to be described hereinafter can be used. Of these, hydroquinone compounds and hindered amine compounds are particularly preferable. The antioxidant(s) to be used at this point in time in the present invention will be added for the purpose of protecting the compound represented by any one of General Formulas (1) and (2), the purpose being different from the purpose to be described below. For this reason, it is preferable that the antioxidant is added to the coating solution in a step before the compound represented by any one of General Formulas (1) and (2) is added to the coating solution. The additive amount of the antioxidant is preferably 0.1 parts by mass to 200 parts by mass to 100 parts by mass of the organic compound having an acidic value of 10 mgKOH/g to 700 mgKOH/g to ensure sufficient storage stability of the coating solution with a lapse of time.

A method of applying the thus obtained coating solution is not particularly limited and may be suitably selected in accordance with the intended use. For example, conventional coating methods such as immersion coating method, spray coating, bead coating, nozzle coating, spinner coating and ring coating can be used.

### —Substrate—

The substrate is not particularly limited and may be suitably selected in accordance with the intended use as long as it exhibits conductive property of a volume resistance of 10¹⁰ Ω·cm or less. For example, the substrate may be formed by coating a film-like or cylindrical piece of plastic or paper with a metal such as aluminum, nickel, chrome, nichrome, copper, gold, silver or platinum or a metal oxide such as tin oxide or indium oxide by vapor deposition or sputtering; the substrate may be a plate of aluminum, aluminum alloy, nickel, stainless, etc., or a plate formed into a tube by extrusion or drawing and surface treating by cut, superfinishing and polishing can be used. Also, an endless nickel belt or an endless stainless belt disclosed in Japanese Patent Application Laid-Open (JP-A) No. 52-36016 can be used as a substrate. Also, the substrate may be a nickel foil having a thickness of 50 μm to 150 μm, or the a substrate may be prepared by subjecting a surface of a polyethylene terephthalate film having a thickness of 50 μm to 150 μm to a conductive treatment such as aluminum evaporation.

Besides, a substrate prepared by dispersing a conductive fine particle into a suitable binder resin and coating onto a substrate material can be used in the present invention.

Examples of the conductive powder include carbon black, acetylene black, a metal powder of aluminum, nickel, iron, nichrome, copper, zinc, silver, etc., or a metal oxide powder of conductive tin oxide and ITO. Examples of the binder resin used together with the conductive powder include polystyrene resins, styrene-acrylonitrile copolymers, styrene-butadiene copolymers, styrene-maleic anhydride copolymers, polyester resins, polyvinyl chlorides, polyarylate resins, phenoxy resins, polycarbonate resins, cellulose acetate resins, ethylcellulose resins, polyvinyl butyral resins, polyvinyl formal resins, polyvinyltoluene resins, poly-N-vinylcarbazole, acrylic resins, silicone resins, epoxy resins, melamine resins, urethane resins, phenol resins and alkyd resins.

Such a conductive layer can be provided by dispersing the conductive powder and binder resin in a suitable solvent, for example tetrahydrofuran, dichloromethane, methyl ethyl ketone or toluene, and then applying them.

Further, the substrate which is prepared by forming a conductive layer on a suitable cylindrical base with a thermal contraction inner tube containing the conductive powder in a suitable material such as polyvinyl chloride, polypropylene, polyester, polystyrene, polyvinylidene chloride, polyethylene, chlorinated rubber or TEFLON (registered trademark) can also be favorably used as the conductive substrate in the present invention.

### —Multi-Layered Photosensitive Layer—

The multi-layered photosensitive layer has at least a charge generating layer and a charge transporting layer formed in this order and further has a protective layer, an intermediate layer and other layers in accordance with necessity.

### —Charge Generating Layer—

The charge generating layer contains at least a charge generating material and a binder resin and further contains other components in accordance with necessity.

The charge generating material is not particularly limited and may be suitably selected in accordance with the intended use, and any one of an inorganic material and an organic material can be used.

The inorganic material is not particularly limited and may be suitably selected in accordance with the intended use. Examples thereof include crystalline seleniums, amorphous-seleniums, selenium-tellurium-halogen and selenium-arsenic compounds.

The organic material is not particularly limited and may be suitably selected from among conventional materials in accordance with the intended use. Examples thereof include C.I. Pigment Blue 25 (Color Index C.I. 21180), C.I. Pigment Red 41 (C.I. 21200), C.I Acid Red 52 (C.I. 45100), C.I. Basic Red 3 (C.I. 45210), azo pigments having a carbazole skeleton, azo pigments having distyryl benzene skeleton, azo pigments having a triphenylamine skeleton, azo pigments having a dibenzothiophene skeleton, azo pigments having an oxadiazole skeleton, azo pigments having a fluorenone skeleton, azo pigments having a bisstilbene skeleton, azo pigments having a distyryloxadiazole skeleton, azo pigments having a distyryl carbazole skeleton; phthalocyanine pigments such as C.I. Pigment Blue 16 (C.I. 74100); indigo pigments such as C.I Bat Brown (C.I. 73410) and C.I. Bat Dye (C.I. 730.50); perylene pigments such as ALGOL SCARLET B (manufactured by Bayer Co., Ltd.) and INDANTHRENE SCARLET R (manufactured by Bayer Co., Ltd.); and squaric dyes. Each of these organic pigments may be used alone or in combination with two or more.

The binder resin is not particularly limited and may be suitably selected in accordance with the intended use. Examples thereof include polyamide resins, polyurethane resins, epoxy resins, polyketone resins, polycarbonate resins, silicone resins, acryl resins, polyvinylbutyral resins, polyvinylformal resins, polyvinylketones resins, polystyrene resins, poly-N-vinylcarbazole resins, polyacrylamide resins, polyester resins, phenoxy resins, vinyl chloride-vinyl acetate copolymers, polyvinyl acetates, polyphenylene oxides, polyvinyl alcohols, polyvinyl pyrolidones and cellulose resins. Each of these may be used alone or in combination with two or more.

The additive amount of the binder resin is 0 parts by mass to 500 parts by mass and more preferably 10 parts by mass to 300 parts by mass to 100 parts by mass of the charge generating material. The binder resins may be added before or after the dispersion treatment.

Methods of forming the charge generating layer are broadly classified into vacuum thin-layer forming method and casting method using a solution dispersion liquid.

Examples of the former method, i.e., the vacuum thin-layer forming method include glow discharge decomposition, vacuum evaporation method, CVD method, sputtering method, reactive sputtering method, ion-plating method and accelerating ion-injection method. By the vacuum thin-layer forming method, the charge generating layer can be favorably formed with the use of the organic materials or the inorganic materials stated above.

Further, to form a charge generating layer by the latter method, i.e., the casting method, it can be formed by the use of a commonly used method such as immersion coating method, spray coating method and bead coating method.

An organic solvent used for the charge generating layer coating solution is not particularly limited and may be suitably selected in accordance with the intended use. Examples thereof include acetone, methylethylketone, methyl isopropyl ketone, cyclohexanone, benzene, toluene, chloroform, dichloromethane, dichloroethane, dichloropropane, trichloroethane, trichloroethylene, tetrachloroethane, tetrahydrofuran, dioxsolan, dioxane, methanol, ethanol, isopropyl alcohol, butanol, ethyl acetate, butyl acetate, dimethylsulfoxide, methylcellosolve, ethyl cellosolve and propyl cellosolve. Each of these may be used alone or in combination with two or more.

Of these, tetrahydrofuran, methylethylketone, dichloromethane, methanol and ethanol, each of which has a boiling point of 40° C. to 80° C., are particularly preferable from the perspective of easiness of drying after being applied.

The charge generating layer coating solution is prepared by dispersing and dissolving the charge generating material and a binder resin in the above-noted organic solvent. For the method of dispersing an organic pigment in the organic solvent, for example, a dispersing method using a dispersion medium, for example, a ball mill, a bead mill, a sand mill and vibration mill and high-speed liquid collision dispersion methods are exemplified.

The thickness of the charge generating layer is preferably 0.01 μm to 5 μm, and more preferably 0.05 μm to 2 μm.

### —Charge Transporting Layer—

The charge transporting layer is formed for the purposes of maintaining a charge and transporting a charge separately generated in the charge generating layer by exposure to combine the charge with the maintained charge. To achieve the purpose of maintaining a charge, it is required to have a high electrical resistivity. Further, to achieve the purpose of obtaining a high-surface potential with the maintained charge, it is required to have a small dielectric constant and excellent charge transportability.

The charge transporting layer contains at least a charge transporting material. When the charge transporting layer constitutes the outermost surface layer of the electrophotographic photoconductor, the charge transporting layer contains a compound represented by any one of General Formulas (1) and (2), a filler, an organic compound having an acidic value of 10 mgKOH/g to 700 mgKOH/g, a binder resin and further contains other components in accordance with necessity.

For the compound represented by any one of General Formulas (1) and (2), the filler and the organic compound having an acidic value of 10 mgKOH/g to 700 mgKOH/g, all the compounds described above for the outermost surface layer can be used.

For the charge transporting material, a low-molecular weight charge transporting material such as an electron hole transporting material and an electron transporting material can be used, and where necessary, a polymer charge transporting material can be further added to the charge transporting material.

Examples of the electron transporting material or electron accepting material include chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-on and 1,3,7-trinitrodibenzothiophene-5,5-dioxide. Each of these may be used alone or in combination with two or more.

Examples of the electron hole transporting material or electron donating material include oxazole derivatives, oxadiazole derivatives, imidazole derivatives, triphenylamine derivatives, 9-(p-diethylaminostyrylanthradene), 1,1-bis-(4-dibenzylaminophenyl)propane, styrylanthracene, styrylpyrazoline, phenyl-hydrazones, α-phenyl-stilbene derivatives, thiazole derivatives, triazole derivatives, phenazine derivatives, acridine derivatives, benzofuran derivatives, benzimidazole derivatives and thiophene derivatives. Each of these may be used alone or in combination with two or more.

For the polymer charge transporting material, compounds having the following structures are exemplified.

(a) for polymers having a carbazole ring, for example, poly-N-vinyl carbazole; and the compounds descried in Japanese Patent Application Laid-Open (JP-A) Nos. 50-82056, 54-9632, 54-11737, 4-175337, 4-183719 and 6-234841 are exemplified.

(b) for polymers having a hydrozone structure, for example, the compounds described in Japanese Patent Application Laid-Open (JP-A) Nos. 57-78402, 61-20953, 61-296358, 1-134456, 1-179164, 3-180851, 3-180852, 3-50555, 5-310904 and 6-234840 are exemplified.

(c) for polysilylene polymers, for example, the compounds described in Japanese Patent Application Laid-Open (JP-A) Nos. 63-285552, 1-88461, 4-264130, 4-264131, 4-264132, 4-264133 and 4-289867 are exemplified.

(d) polymers having a triarylamine structure, for example, N,N-bis(4-methylphenyl)-4-aminopolystyrene, the compounds described in Japanese Patent Application Laid-Open (JP-A) Nos. 1-134457, 2-282264, 2-304456, 4-133065, 4-133066, 5-40350 and 5-202135 are exemplified.

(e) for other polymers, for example, formaldehyde condensate polymers of nitropyrene, the compounds described in Japanese Patent Application Laid-Open (JP-A) Nos. 51-73888, 56-150749, 6-234836 and 6-234837 are exemplified.

Besides those stated above, examples of the polymer charge transporting material include polycarbonate resins having a triarylamine structure, polyurethane resins having a triarylamine structure, polyester resins having a triarylamine structure and polyether resins having a triarylamine structure. Specific examples of the polymer charge transporting material include the compounds described in 64-1728, 64-13061, 64-19049, 4-11627, 4-225014, 4-230767, 4-320420, 5-232727, 7-56374, 9-127713, 9-222740, 9-265197, 9-211877 and 9-304956 are exemplified.

For a polymer having an electron donating group, not only the above-noted polymers but also a copolymer with a known monomer, a block polymer, a graft polymer, a star polymer, further, a crosslinkable polymer having an electron donating group as disclosed, for example, in Japanese Patent Application Laid-Open (JP-A) No. 3-109406 can be used.

Examples of the binder resin include polystyrenes, styrene - acrylonitrile copolymers, styrene -butadiene copolymers, styrene-maleic anhydride copolymers, polycarbonate resins, polyester resins, methacrylic resins, acrylic resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinyl carbazole resins, polyvinyl butyral resins, polyvinyl formal resins, polyacrylate resins, polyacrylamide resins and phenoxy resins. Each of these binder resins may be used alone or in combination with two or more.

The charge transporting layer can contain a copolymer of a crosslinkable binder with a crosslinkable charge transporting material.

The content of the charge transporting material is preferably 20 parts by mass to 300 parts by mass, and more preferably 40 parts by mass to 150 parts by mass to 100 parts by mass of the binder resin.

The charge transporting layer can be formed by dissolving or dispersing the charge transporting material and the binder resin in an appropriate solvent, applying and drying it. To the charge transporting layer, additives such as a plasticizer, an antioxidant and a leveling agent can be added in an appropriate amount in accordance with necessity, besides the charge transporting material and the binder resin.

The thickness of the charge transporting layer is preferably 25 μm or less in terms of resolution and responsiveness, and the minimum value thereof varies depending on the used system, in particular, depending on charge potential and the like, however, it is preferably 5 μm or more.

### —Single-Layer Photosensitive Layer—

The single-layered photosensitive layer contains a charge generating material, a charge transporting material, a binder resin and further contains other components in accordance with necessity.

For the charge generating material, the charge transporting material and the binder resin, the materials stated above can be used. Examples of the other components include plasticizers, fine particles and various additives. The additive amount of the charge generating material is preferably 5 parts by mass to 40 parts by mass to 100 parts by mass of the binder resin. The additive amount of the charge transporting material is preferably 0 parts by mass to 190 parts by mass, and more preferably 50 parts by mass to 150 parts by mass to 100 parts by mass of the binder resin.

When the single-layered photosensitive layer constitutes the outermost surface layer, the single-layered photosensitive layer contains a compound represented by any one of General Formulas (1) and (2) and a filler and an organic compound having an acidic value of 10 mgKOH/g to 700 mgKOH/g.

For the compound represented by any one of General Formulas (1) and (2), the filler and the organic compound having an acidic value of 10 mgKOH/g to 700 mgKOH/g, all the compounds described stated above for the outermost surface layer can be used.

In this case, the filler contained in the entire photosensitive layer. However, since the outermost layer containing a filler is effective in terms of improving abrasion resistance of the outermost surface layer, a concentration gradient of the filler may be provided or the photosensitive layer may be multi-layered with a concentration gradient so that each of layers has a different filler concentration.

The thickness of the single-layered photosensitive layer is not particularly limited and may be suitably adjusted in accordance with the intended use, and it is preferably 5 μm to 25 μm.

### —Protective Layer—

In the electrophotographic photoconductor of the present invention, for the purpose of protecting the photosensitive layer and improving durability thereof, as the outermost surface layer, a protective layer containing a filler can be formed on the photosensitive layer. When the protective layer is formed as the outermost surface layer, the protective layer contains a compound represented by any one of General Formulas (1) and (2), a filler, a binder resin and an organic compound having an acidic value of 10 mgKOH/g to 700 mgKOH/g.

For the compound represented by any one of General Formulas (1) and (2), the filler and the organic compound having an acidic value of 10 mgKOH/g to 700 mgKOH/g, all the compounds described above for the outermost surface layer can be used.

Examples of the binder resin include AS resins, ABS resins, ACS resins, olefin-vinyl monomer copolymers, chlorinated polyether resins, allyl resins, phenol resins, polyacetal resins, polyamide resins, polyamideimide resins, polyacrylate resins, polyallyl sulfone resins, polybutylene resins, polybutylene terephthalate resins, polycarbonate resins, polyether sulfone resins, polyethylene resins, polyethylene terephthalate resins, polyimide resins, acrylic resins, polymethyl pentene resins, polypropylene resins, polyphenylene oxide resins, polysulfone resins, polyurethane resins, polyvinyl chloride resins, polyvinylidene chloride resins and epoxy resins.

Adding the low-molecular weight charge transporting material or the polymer charge transporting material, described above in the charge transporting layer, to the protective layer is effective and useful for reducing a residual potential and improving the quality of images.

The filler can be dispersed along with at least an organic solvent, the organic compound having an acidic value of 10 mgKOH/g to 700 mgKOH/g etc. using a conventional dispersing device such as a ball mill, an attritor, a sand mill or an ultrasonic wave. Of these dispersing devices, it is more preferable to use a ball mill from the perspective that it allows for increasing the contact efficiency between the filler and the organic compound having an acidic value of 10 mgKOH/g to 700 mgKOH/g and causes less amount of impurities mixed from the outside.

It is preferable to add the organic compound having an acidic value of 10 mgKOH/g to 700 mgKOH/g to a coating solution for the protective layer along with the filler and the organic solvent before the dispersion treatment of the filler, because it can prevent the filler from flocculating in the coating solution, can suppress the sedimentation property of the filler and can remarkably improve the dispersibility of the filler. In the meanwhile, the binder resin and the charge transporting material can be added to the coating solution before the dispersion treatment, however, in this case, a slight reduction in dispersibility of the filler may be observed. For this reason, the binder resin and the charge transporting material are preferably added in a state of being dissolved in an organic solvent to the dispersed coating solution after the dispersion treatment of the filler.

A method of forming the protective layer is not particularly limited and may be suitably selected in accordance with the intended use. Examples thereof include immersion coating method, spray coating method, bead coating method, nozzle coating method, spinner coating method and ring coating method. Of these methods, spray coating method is particularly preferable from the perspective of uniformity of coated film. Further, the protective layer may be formed by applying the coating solution once so as to ensure a necessary thickness, however, it is more preferable to form a protective layer by applying the coating solution two times or more to make the protective layer multi-layered from the perspective of uniformity of the filler in the protective layer. With this, further effects of reducing residual potential, enhancing resolution and improving abrasion resistance can be obtained.

The thickness of the protective layer is preferably 0.1 μm to 10 μm. By adding the organic compound having an acidic value of 10 mgKOH/g to 700 mgKOH/g to the coating solution, residual potential of the electrophotographic photoconductor can be drastically reduced, which enables arbitrarily designing of the thickness of the protective layer. However, a significant increase in thickness of the protective layer tends to cause a slight degradation in image quality, and thus it is preferable to set the thickness to the required minimum thickness.

### —Undercoat Layer—

Between the substrate and the photosensitive layer, an undercoat layer may be formed in accordance with necessity. The undercoat layer is formed for the purposes of improving adhesion property, preventing occurrence of moire, improving the coating property of upper layers and reducing the residual potential.

The undercoat layer contains at least a resin and a fine powder and further contains other components in accordance with necessity.

Examples of the resin include water-soluble resins such as polyvinyl alcohol resins, caseins and sodium polyacrylate; alcohol-soluble resins such as copolymer nylons and methoxy methylated nylons; and curable resins capable of forming a three-dimensional network structure such as polyurethane resins, melamine resins, alkyd-melamine resins and epoxy resins.

Examples of the fine powder include metal oxides, metal sulfides or metal nitrides of, for example, titanium oxides, silicas, aluminas, zirconium oxides, tin oxides and indium oxides.

For the undercoat layer, a coating solution containing a silane coupling agent, a titanium coupling agent and/or chrome coupling agent can also be used. Further, as the undercoat layer, an undercoat layer formed by anodizing Al₂O₃, and an undercoat layer formed with an organic material such as polyparaxylylene (parylene) or an inorganic material such as SiO₂, SnO₂, TiO₂, ITO and CeO₂ by a vacuum thin-layer forming method can also be used.

The thickness of the undercoat layer is not particularly limited and may be suitably adjusted in accordance with the intended use, and it is preferably 0.1 μm to 10 μm, and more preferably 1 μm to 5 μm.

In the electrophotographic photoconductor of the present invention, for the purpose of improving adhesion property and charge blocking property, an intermediate layer may be formed on the substrate in accordance with necessity. The intermediate layer primarily contains a resin, however, the resin is preferably a resin having a high-solvent resistance to organic solvents in consideration that a solvent is applied over the surface of the resin to form the photosensitive layer. For the resin, a similar resin to that used for the undercoat layer can be suitably selected for use.

Furthermore, in the electrophotographic photoconductor of the present invention, for the purpose of improving environmental resistance, in particular, for the purpose of preventing a reduction in photosensitivity and an increase in residual potential on the electrophotographic photoconductor, an antioxidant, a plasticizer, a lubricant, an ultraviolet absorbent, a low-molecular weight charge tra nsporting material, a leveling agent and the like can be added to respective layers such as the charge generating layer, the charge transporting layer, the undercoat layer, the protective layer and the single-layered photosensitive layer.

Examples of the antioxidant include phenol compounds, paraphenylene diamines, organic sulfur compounds and organic phosphorous compounds.

Examples of the phenol compounds include 2,6-di-t-butyl-p-cresol, butylated hydroxyanisol, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-buthylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butylic acid]glycol ester and tocopherols.

Examples of the paraphenylenediamines include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′- dimethyl-N,N′-di-t-butyl-p-phenylenediamine.

Examples of the hydroquinones include 2,5-di-t-octylhydroquinone, 2,6-didodecylhydroquinone, 2-dodecylhydroquinone, 2-dodecyl-5-chlorohydroquinone, 2-t-octyl-5-methylhydroquinone and 2-(2-octadecenyl)-5-methylhydroquinone.

Examples of the organic sulfur compounds include dilauryl-3,3′-thiodipropyonate, distearyl-3,3′-thiodipropyonate, ditetradecyl-3,3′-thiodipropyonate.

Examples of the organic phosphorous compounds include triphenylphosphine, tri(nonylphenyl)phosphine, tri(dinonylphenyl)phosphine, tricresyl phosphine and tri(2,4-dibutylphenoxy)phosphine.

These compounds are known as antioxidants for fats and fatty oils, the commercial products thereof are easily available.

The additive amount of the antioxidant is preferably 0.01% by mass to 10% by mass.

Plasticizers that can be added to the respective layers are not particularly limited and may be suitably selected in accordance with the intended use. Examples thereof include phosphoric acid ester plasticizers, phthalic acid ester compounds, aromatic carboxylic acid ester plasticizers, aliphatic dibasic acid ester plasticizers, fatty acid ester derivatives, oxyester plasticizers, divalent alcohol ester plasticizers, chlorine-containing plasticizers, polyester plasticizers, sulfonic acid derivatives, citric acid derivatives and other plasticizers.

Examples of the phosphoric acid ester plasticizers include triphenyl phosphate, tricresyl phosphate, trioctyl phosphate, octyldiphenyl phosphate, trichloroethyl phosphate, cresylphenyl phosphate, tributyl phosphate, tri-2-ethylhexyl phosphate and triphenyl phosphate.

Examples of the phthalic acid ester plasticizers include dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyl lauryl phthalate, methyl oleyl phthalate, octyldecyl phthalate, dibutyl fumarate and dioctyl fumarate.

Examples of the aromatic carboxylic acid ester plasticizers include trioctyl trimellitate, tri-n-octyl trimellitate, and octyloxy benzoate.

Examples of the aliphatic dibasic acid ester plasticizers include dibutyl adipate, di-n-hexyl adipate, di-2-ethylhexyl adipate, di-n-octyl adipate, n-octyl-n-decyl adipate, diisodecyl adipate, dicapryl adipate, di-2-ethylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate and di-n-octyl tetrahydrophthalate.

Examples of the fatty acid ester derivatives include butyl oleate, glycerine monooleater ester, methylacetyl ricinoleate, pentaerythritol ester, dipentaerythritol hexaester, triacetine and tributyrin.

Examples of the oxy acid ester plasticizers include methylacetyl ricinoleate, butylacetyl ricinoleate, butylphthalyl butyl glycolate and tributyl acetyl citrate.

Examples of the epoxy plasticizers include epoxidized soybean oil, epoxidized linseed oil, epoxy butyl stearate, epoxy decyl stearate, epoxy octyl stearate, epoxy benzyl stearate, epoxy dioctyl hexahydrophthalate and epoxy didecyl hexahydrophthalate.

Examples of the divalent alcohol ester plasticizers include diethylene glycol dibenzoate and triethylene glycol di-2-ethyl butyrate.

Examples of the chlorine-containing plasticizers include chlorinated paraffin, chlorinated diphenyl, chlorinated methyl fatty acid and methoxy chlorinated methyl fatty acid.

Examples of the polyester plasticizers include polypropylene adipate, polypropylene sebacate, polyester and acetylated polyester.

Examples of the sulfonic acid derivatives include p-toluene sulfone amide, o-toluene sulfone amide, p-toluene sulfone ethyl amide, o-toluene sulfone ethyl amide, toluene sulfone-N-ethyl amide and p-toluene sulfone-N-cyclohexyl amide.

Examples of the citric acid derivatives include triethyl citrate, triethyl acetyl citrate, tributyl citrate, tributyl acetyl citrate, tri-2-ethylhexyl acetyl citrate and n-octyldecyl acetyl citrate.

Examples of the other plasticizers include terphenyl, partly hydrogenerated terphenyl, camphor, 2-nitrodiphenyl, dinonyl naphthalene and methyl abietate.

Lubricants that can be added to the respective layers are not particularly limited and may be suitably selected in accordance with the intended use. Examples thereof include hydrocarbon compounds, fatty acid compounds, fatty acid amide compounds, ester compounds, alcohol compounds, metal soaps, natural waxes and other lubricants.

Examples of the hydrocarbon compounds include liquid paraffins, paraffin waxes, micro waxes and low polymer polyethylenes.

Examples of the fatty acid compounds include lauric acids, myristic acids, palmitic acids, stearic acids, arachic acids and behenic acids.

Examples of the fatty acid amide compounds include stearylamide, palmityl amide, oleinamide, methylenebis stearoamide and ethylenebis stearoamide.

Examples of the ester compounds include lower alcohol esters of fatty acids, polyvalent alcohol esters of fatty acids and polyglycol esters of fatty acids.

Examples of the alcohol compounds include cetyl alcohols, stearyl alcohols, ethylene glycols, polyethylene glycols and polyglycerols.

Examples of the metal soaps include lead stearates, cadmium stearates, barium stearates, calcium stearates, zinc stearates and magnesium stearates.

Examples of the natural waxes include carnauba waxes, candelilla waxes, bee waxes, whale waxes, privet waxes and montan waxes.

Examples of the other lubricants include silicone compounds and fluorine compounds.

Ultraviolet absorbents that can be added to the respective layers are not particularly limited and may be suitably selected in accordance with the intended use. Examples thereof include benzophenone ultraviolet absorbents, salicylate ultraviolet absorbents, salicylate ultraviolet absorbents, benzotriazole ultraviolet absorbents, cyanoacrylate ultraviolet absorbents, quencher (metal complex salt) ultraviolet absorbers and HALS (hindered amine).

Examples of the benzophenone ultraviolet absorbents include 2-hydroxybenzophenone, 2,4-dihydroxybenzophenone, 2,2′,4-trihydroxybenzophenone, 2,2′,4,4′-tetrahydroxybenzophenone and 2,2′-dihydroxy 4-methoxybenzophenone.

Examples of the salicylate ultraviolet absorbents include phenyl salicylate and 2,4-di-t-butylphenyl-3,5-di-t-butyl-4-hydroxybenzoate.

Examples of the benzotriazole ultraviolet absorbents include (2′-hydroxyphenyl)benzotriazole, (2′-hydroxy 5′-methylphenyl)benzotriazole and (2′-hydroxy 3′-tertiary butyl 5′-methylphenyl)5-chlorobenzotriazole.

Examples of the cyanoacrylate ultraviolet absorbents include ethyl-2-cyano-3,3-diphenyl acrylate and methyl 2-carbomethoxy 3(paramethoxy)acrylate.

Examples of the quencher (metal complex salt) ultraviolet absorbents include nickel (2,2′thiobis(4-t-octyl)phenolate) normal butylamine, nickel dibutyldithio carbamate, nickel dibutyldithio carbamate and cobalt dicyclohexyl dithio phosphate.

Examples of the HALS (hindered amine) include bis(2,2,6,6-tetramethyl-4-piperidyl)sebacate, bis(1,2,2,6,6-pentamethyl-4-piperidyl)sebacate, 1-{2-[3-(3,5-di-t-butyl-4-hydroxyphenyl)propionyloxy]ethyl}-4-[3-(3,5-di-t-butyl-4-hydroxyphenyl)propionyloxy]-2,2,6,6-tetramethyl pyridine, 8-benzyl-7,7,9,9-tetramethyl-3-octyl-1,3,8-triazaspiro[4,5]undecan-2,4-dion and 4-benzoyloxy-2,2,6,6-tetramethyl piperidine.

### <Charging Step and Charging Unit>

The charging step is a step in which the surface of an electrophotographic photoconductor is charged by using a charging unit.

The charging unit is not particularly limited and may be suitably selected in accordance with the intended use as long as it can apply a voltage to the surface of the electrophotographic photoconductor to uniformly charge the surface, however, a non-contact type charging unit that can charge the surface in non-contact with the surface of the electrophotographic photoconductor is used in the present invention.

Examples of the non-contact type charging unit include non-contact chargers utilizing a corona discharge, a needle electrode device, a solid discharge device; a conductive or semi-conductive charge roller placed in a narrow space with an electrophotographic photoconductor. Of these, non-contact chargers utilizing a corona discharge are particularly preferable.

The corona discharge is a charging method in which a positive or negative ion generated by a corona discharge in the air is given to the surface of an electrophotographic photoconductor to charge the electrophotographic photoconductor surface in a non-contact manner. The corona discharge chargers are classified into corotoron chargers having a characteristic that a constant charge amount is given to an electrophotographic photoconductor, and scorotoron charges having a characteristic that a constant electric potential is given to an electrophotographic photoconductor.

The corotoron charger is composed of casing electrodes occupying the half-space thereof around a discharge wire which is positioned roughly in the center of the casing electrodes.

The scorotoron charger is a charger of which grid electrodes are added to the corotoron charger, and the grid electrodes are positioned 1.0 mm to 2.0 mm away from the surface of an electrophotographic photoconductor.

### <Exposing Step and Exposing Unit>

The exposure can be performed by imagewisely exposing the surface of the electrophotographic photoconductor using the exposing unit.

Optical systems used in the exposure are broadly classified into analogue optical systems and digital optical systems. The analogue optical system is an optical system of which an original document is directly projected onto an electrophotographic photoconductor through the use of an optical system. The digital optical system is an optical system in which an image is formed by giving image information as electric signals and converting the electric signals into light signals and exposing an electrophotographic photoconductor using the light signals.

The exposing unit is not particularly limited and may be suitably selected in accordance with the intended use as long as it can imagewisely expose the electrophotographic photoconductor surface that has been charged by the charging unit. Examples thereof include various exposers such as reproducing optical systems, rod lens array systems, laser optical systems, liquid crystal shutter optical systems and LED optical systems.

In the present invention, the back light method may be employed in which exposure is performed imagewisely from the back side of the photoconductor.

### —Developing Step and Developing Unit—

The developing step is a step in which the latent electrostatic image is developed using a toner or a developer to form a visible image.

The visible image can be formed, for example, by developing the latent electrostatic image using the toner or the developer, by means of the developing unit.

The developing unit is not particularly limited and may be suitably selected from among those known in the art as long as it can develop an image using the toner or the developer. For example, a developing unit having at least a developing device which houses the toner or the developer and supplies the toner or the developer to the latent electrostatic image in a contact or non-contact state is preferably exemplified.

The developing device may employ a dry-developing process or a wet-developing process. It may be a monochrome color image developing device or a multi-color image developing device. Preferred examples thereof include a developing device having a stirrer by which the toner or the developer is frictionally stirred to be charged, and a rotatable magnet roller.

In the image developing device, for example, the toner and a carrier are mixed and stirred, the toner is charged by frictional force at that time to be held in a state where the toner is standing on the surface of the rotating magnet roller to thereby form a magnetic brush. Since the magnet roller is located near the electrophotographic photoconductor (photoconductor), a part of the toner constituting the magnetic brush formed on the surface of the magnet roller moves to the surface of the electrophotographic photoconductor by an electric attraction force. As the result, the latent electrostatic image is developed using the toner to form a visible toner image on the surface of the electrophotographic photoconductor.

The developer to be housed in the developing device is a developer which contains the toner, however, the developer may be a one-component developer or a two-component developer.

### —Transferring Step and Transferring Unit—

The transferring step is a step in which the visible image is transferred onto a recording medium, and it is preferably an aspect in which an intermediate transfer member is used, the visible image is primarily transferred to the intermediate transfer member and then the visible image is secondarily transferred onto the recording medium. Another aspect of the transferring step is more preferable, which includes, using two or more color toners, still more preferably, using a full-color toner, a primary transferring step in which the visible image is transferred to an intermediate transfer member to form a composite transfer image thereon, and a secondary transferring step in which the composite transfer image is transferred onto a recording medium.

The transferring can be performed, for example, by charging the visible image formed on the surface of the electrophotographic photoconductor using a transfer-charger, and this is enabled by means of the transfer unit. For the transfer unit, it is preferably an aspect which includes a primary transfer unit configured to transfer the visible image to an intermediate transfer member to form a composite transfer image, and a secondary transfer unit configured to transfer the composite transfer image onto a recording medium.

The intermediate transfer member is not particularly limited, may be suitably selected from among those known in the art in accordance with the intended use, and preferred examples thereof include transfer belts.

The transfer unit (the primary transfer unit and the secondary transfer unit) preferably includes at least an image-transferer configured to exfoliate and charge the visible image formed on the electrophotographic photoconductor to transfer the visible image onto the recording medium. The transfer unit may be one transfer unit or two or more transfer units.

Examples of the image transferer include corona transferers utilizing a corona discharge electrode, transfer belts, transfer rollers, pressure transfer rollers and adhesion image transfer units.

The recording medium is typified by regular paper, however, is not particularly limited and may be suitably selected from conventional recording media, provided that developed but unfixed images can be transferred thereonto. PET based recording media for OHP can also be used.

### —Fixing Step and Fixing Unit—

The fixing step is a step in which the visible image transferred onto the recording medium is fixed using a fixing device. Fixing of the image can be performed every time each color toner is transferred onto the recording medium or at a time so that each of individual color toners are superimposed at the same time.

The fixing unit is not particularly limited and may be suitably selected in accordance with the intended use, however, a fixing unit having a fixing member and a heat source for heating the fixing member is used in the present invention.

Examples of the fixing member include a combination of an endless belt and a roller and a combination of a roller and a roller. It is preferable to use a combination of an endless belt which is small in heat capacity, and a roller in terms of its capability of shortening the warm-up time length, realization of saving of energy and enlarging a fixable width.

The charge-eliminating step is a step in which a charge-eliminating bias is applied to the electrophotographic photoconductor to eliminate a residual charge on the electrophotographic photoconductor. The charge elimination can be preferably carried out by means of a charge-eliminating unit.

The charge-eliminating unit is not particularly limited as long as it can apply a charge-eliminating bias to the electrophotographic photoconductor, and may be suitably selected from among conventional charge-eliminating devices. For example, a charge-eliminating lamp or the like can be preferably used.

In the present invention, it is preferable that the charge eliminating exposure dose of the charge eliminating unit is controlled at at least two stages during a time from the start of an image forming operation to the end of the image forming operation, i.e., from when the electrophotographic photoconductor is driven to rotate until the rotation of the electrophotographic photoconductor is stopped. Specifically, it is preferable that a charge eliminating exposure dose A of the charge eliminating unit in working condition is set to be lower than a charge eliminating exposure dose B of the charge eliminating unit that is used to irradiate the electrophotographic photoconductor for a time length of at least one rotation or more of the electrophotographic photoconductor just before the stoppage of rotation thereof. As a result, accumulated energy of the charge eliminating light used to irradiate the electrophotographic photoconductor can be reduced, and an increase in residual potential that could be caused by light fatigue etc. can be reduced. The charge eliminating exposure dose A is preferably ¼ to ⅔ of the charge eliminating exposure dose B and more preferably ¼ to ½ of the charge eliminating exposure dose B. When the charge eliminating exposure dose A is less than ¼ of the charge eliminating exposure dose B, incidental images easily occur in the successive image forming process, and when more than ⅔ of the charge eliminating exposure dose B, the effect of reducing an increase in residual potential may be insufficient.

The cleaning step is a step in which a residual toner remaining on the electrophotographic photoconductor is removed. The cleaning of the electrophotographic photoconductor can be suitably performed by a cleaning unit. It is also possible to employ a method in which the charge of a residual toner is almost uniformed with a rubbing member and then collected with a developing roller.

The cleaning unit is not particularly limited as long as a residual electrophotographic toner remaining on the electrophotographic photoconductor can be removed with the cleaning unit. The cleaner may be favorably selected from among those known in the art. Preferred examples thereof include magnetic brush cleaners, electrostatic brush cleaners, magnetic roller cleaners, blade cleaners, brush cleaners and web cleaners.

The recycling step is a step in which the residual toner removed in the cleaning step is recycled to the developing unit. The recycling is favorably carried out by means of a recycling unit. The recycling unit is not particularly limited. Examples thereof include conventional conveying units.

The controlling step is a step in which the respective steps are controlled, and the control of the respective steps can be favorably carried out.

The controlling unit is not particularly limited as long as it can control operations of the respective units, and may be suitably selected in accordance with the intended use. Examples thereof include equipment such as sequencers and computers.

Here, FIG. 6 is a schematic view showing one example of an image forming apparatus of the present invention. In FIG. 6, an electrophotographic photoconductor 1 is provided with at least a photosensitive layer, and the outermost surface layer contains a compound represented by any one of General Formulas (1) and (2) and a filler. In FIG. 6, the electrophotographic photoconductor 1 is formed in a drum-like shape, however, it may be formed in a sheet-like shape or an endless belt shape. The electrophotographic photoconductor 1 is further provided with a charging charger 3, a pre-transfer charger 7, a transfer charger 10, a separation charger 11 and a pre-cleaning charger 13. For the pre-cleaning charger 13, a corona discharge type charging unit using a non-contact type electrode, for example, a corotoron charger, a scorotoron charger or a solid state charger is used.

For the transfer unit, as shown in FIG. 6, generally, the chargers mentioned above can be used, however, it is effective to use a combination of the transfer charger 10 and the separation charger 11.

Light sources used for exposing unit 5 and a charge eliminating lamp 2 and the like, it is possible to use general illuminants such as a fluorescent light, tungsten lamp, halogen lamp, mercury vapor lamp, sodium lamp, light emitting diode (LED), laser diode (LD) and electro luminescence (EL). For exposing a light having only a desired wavelength, it is possible to use various filters such as a sharp cut filter, band pass filter, near-infrared cutting filter, dichroic filter, interference filter and color temperature conversion filter.

Besides the steps as shown in FIG. 6, the electrophotographic photoconductor may be irradiated with light by providing with steps such as a transferring step, a charge eliminating step, a cleaning step or a pre-exposure in each of which light irradiation is carried out in combination, using a light source.

Next, a toner image developed on the electrophotographic photoconductor by a developing unit 6 is transferred onto a recording medium 9, however, all the toner particles used for the developing are not transferred onto the recording medium 9, and some toner particles remain on the electrophotographic photoconductor 1. Such a residual toner will be removed from the electrophotographic photoconductor 1 by a cleaning unit 16 that is composed of a fur brush 14 and a blade 15. Cleaning of the electrophotographic photoconductor 1 may be performed using only a cleaning brush. For the cleaning brush, a conventional one typified by a fur brush and a magnetic fur brush can be used.

When the electrophotographic photoconductor is positively (negatively) charged and exposed imagewisely, a positively (negatively) charged latent electrostatic image is formed on the surface of the electrophotographic photoconductor. When the positively charged (negatively charged) latent electrostatic image is developed with a negatively polar toner (positively polar toner) (fine particles detectable by an electroscope), a positive image can be obtained. When developed with a positively polar toner (negatively polar toner), a negative image can be obtained. For the developing unit, a conventional unit can be used.

The wavelength of the charge eliminating lamp 2 serving as a charge eliminating unit may be within a wavelength region with which the electrophotographic photoconductor can have photosensitivity, and it is preferably a longer wavelength within a practical photosensitive wavelength region for photoconductors.

Elimination of a residual charge on the electrophotographic photoconductor is carried out not only to stabilize the charge in the subsequent image forming process, after the end of job or image formation process, but also to prevent the latent electrostatic image from appearing as an incidental image(s) in the subsequent process in the successive image formation process. When the rotation of a photoconductor is stopped in a condition of being charged, the electric potential of the photoconductor at the next job start time will be easily unstable, although when the next job will be started is unknown. Therefore, a charge potential of the photoconductor needs to be removed to the level of the residual potential after the image formation process is finished but before the rotation of the photoconductor is stopped. For this reason, generally, a charge eliminating exposure dose is often set to 5 times to 10 times a half exposure dose of a photoconductor used. Since a charge eliminating exposure dose is set to be higher than an exposure energy necessary for forming a latent electrostatic image, an influence of repeating a normal operation of charging-to-exposing and an influence of repetitively irradiating the photoconductor from a charge eliminating unit largely affect the residual potential to easily increase the increased amount of residual potential. Further, in a photoconductor containing a filler in the outermost surface layer, an increased amount of residual potential caused by irradiating the photoconductor with a charge eliminating light tends to increase easily.

In the present invention, accumulated energy of the charge eliminating light used to irradiate the electrophotographic photoconductor can be reduced by eliminating a residual charge on the electrophotographic photoconductor with a charge eliminating exposure dose B for a time length of at least one rotation or more of the electrophotographic photoconductor after the electrophotographic photoconductor has gone through an image formation process but just before the stoppage of rotation of the electrophotographic photoconductor and by setting a charge eliminating exposure dose A that is used to irradiate the electrophotographic photoconductor during image forming operation to a lower value than the charge eliminating exposure dose B, and then irradiating the electrophotographic photoconductor in working condition with the charge eliminating exposure dose A. With the method stated above, an increase in residual potential that could be caused by light fatigue etc. can be reduced. The charge eliminating exposure dose A is preferably ¼ to ⅔ of the charge eliminating exposure dose B and more preferably ¼ to ½ of the charge eliminating exposure dose B.

As various conditions for the cleaning blade, the blade contact angle is preferably ranging from 10 degrees to 30 degrees, the contact pressure is preferably ranging from 0.3 g/mm to 4 g/mm, the rubber hardness of a rubber used for the blade is preferably ranging 60 degrees to 70 degrees, the repulsive elasticity is preferably ranging from 30% to 70%, the Young's modulus is preferably ranging from 30 kgf/cm² to 60 kgf/cm², the thickness is preferably ranging from 1.5 mm to 3.0 mm, the free length is preferably ranging from 7 mm to 12 mm and the biting amount of the blade edge into the electrophotographic photoconductor. As a material satisfying these physical properties, a urethane rubber blade is particularly preferable.

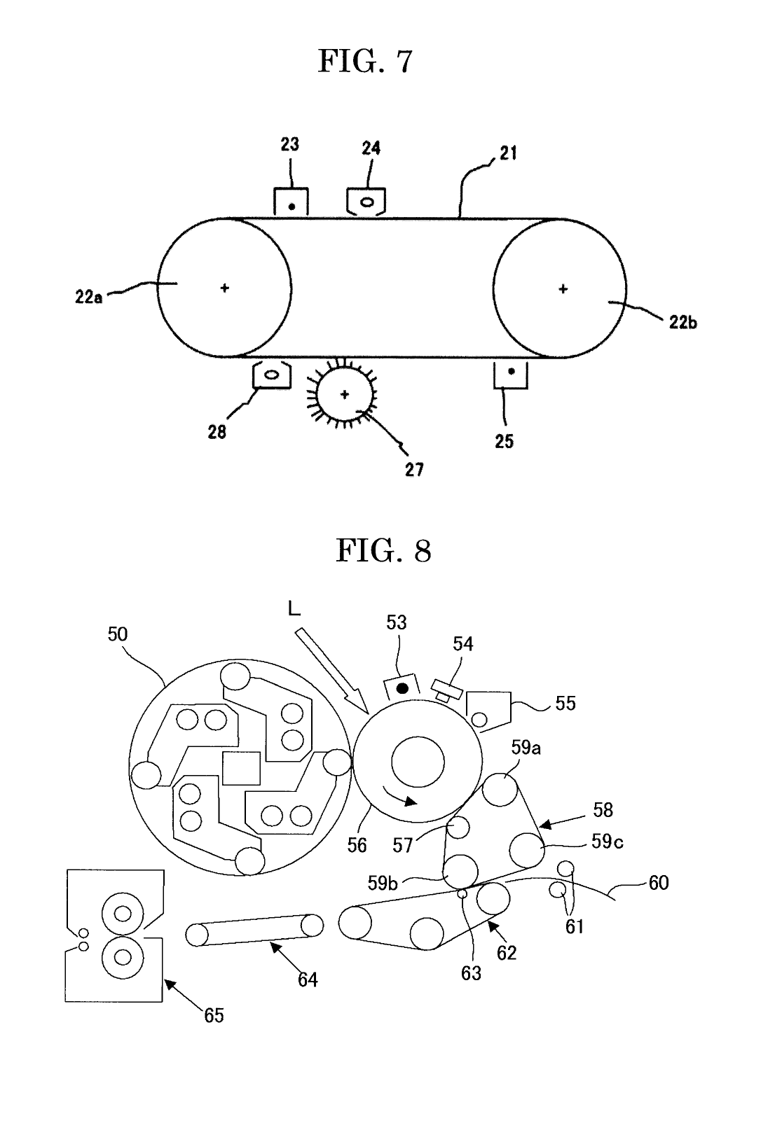

Next, FIG. 7 is a schematic view showing one example of an electrophotographic process according to the present invention. A photoconductor 21 has at least a photosensitive layer and contains a compound represented by any one of General Formulas (1) and (2) and a filler. The photoconductor 21 is driven to rotate drive rollers 22a and 22b, and the surface of the photoconductor 21 is charged by a charger 23, imagewisely exposed by a light source 24, a latent electrostatic image is developed by a developing device (not shown) to form a visible image, the visible image is transferred using a transfer charger 25, the photoconductor surface is cleaned using a brush 27, and residual charge on the photoconductor surface is eliminated by means of a light source 28. A series of the above-mentioned operation is repeatedly performed.

In the electrophotographic process shown in FIG. 7, as light irradiation steps, image exposure, pre-cleaning exposure, and exposure for charge elimination are illustrated in the figure, however, besides, pre-transfer exposure, pre-image exposure and other light irradiation steps known in the art may be provided to irradiate a photoconductor with light.

FIG. 8 is a schematic view exemplarily showing still another embodiment of the image forming apparatus of the present invention. In FIG. 8, the surface of a photoconductor drum 56 is uniformly charged by a charging charger 53 using scorotron or scorotoron while being driven to rotate in the counterclockwise direction in the figure and scanned with a laser light L emitted from a laser optical system (not shown) to thereby bear a latent electrostatic image. Since the photoconductor surface is scanned based on monochrome image information in which full-color image is broken down into color information of yellow, magenta, cyan and black, monochrome latent electrostatic images of yellow, magenta, cyan and black are formed on the photoconductor drum 56. On the left hand side of the photoconductor drum 56 in the figure, a revolver developing unit 50 is placed. The revolver developing unit 50 has a rotating drum housing and has a yellow developing device, a magenta developing device, a cyan developing device and a black developing device in the drum housing and is configured to rotate so as to sequentially move the respective developing devices to a position in which to face the photoconductor drum 56. The yellow developing device, the magenta developing device, the cyan developing device and the black developing device are respectively configured to develop a each color latent electrostatic image by making a yellow toner, a magenta toner, a cyan toner and a black toner adhered thereon.

On the photoconductor drum 56, a yellow latent electrostatic image, a magenta latent electrostatic image, a cyan electrostatic image and a black latent electrostatic image are sequentially formed. These latent electrostatic images are sequentially developed by the respective developing devices placed in the revolver developing unit 50 to be formed as a yellow toner image, a magenta toner image, a cyan toner image and a black toner image.

In the lower stream of the photoconductor drum 56 than the developing position, an intermediate transfer unit is placed. The intermediate transfer unit is provided with a spanned roller 59a, an intermediate transfer bias roller 57 serving as a transfer unit and a secondary transfer backup roller 59b and is configured to move in an endless manner, an intermediate transfer belt 58 that is spanned by a belt drive roller 59c in the clockwise direction in the figure by a rotation drive force given from the belt drive roller 59b. The yellow toner image, the magenta toner image, the cyan toner image and the black toner image developed on the photoconductor drum 56 proceed into an intermediate transfer nip portion at which the photoconductor drum 56 and the intermediate transfer belt 58 make contact with each other and then are intermediately transferred in a state where they are superimposed on the intermediate transfer belt 58 while influenced by a bias from the intermediate transfer bias roller 57, thereby forming a four-color superimposed toner image with the four colors superimposed.

Along with the rotation, the surface of the photoconductor drum 56 that passed the intermediate transfer nip portion is then cleaned by a drum cleaning unit 55 to remove a transfer residual toner remaining thereon. The cleaning unit 55 is configured to remove a transfer residual toner using a cleaning roller to which a cleaning bias is applied, however, it may be the one using a cleaning brush such as a fur brush and a magnetic fur brush, or a cleaning blade.

In the surface of the photoconductor drum 56 on which the transfer residual toner has been removed, a residual charge is eliminated by a charge eliminating lamp 54. For the charge eliminating lamp 54, a fluorescent light, tungsten lamp, halogen lamp, mercury vapor lamp, sodium lamp, light emitting diode (LED), laser diode (LD) and electro luminescence (EL) or the like is used. For a light source of the laser optical system, a semiconductor laser is used. Light emitted from the semiconductor laser may be designed to use only a desired wavelength by using a filter selected from various filters such as sharp cut filters, band pass filters, near-infrared cutting filters, dichroic filters, interference filters and color temperature conversion filters.

In the meanwhile, a pair of resist rollers 61 in which a recording medium 60 sent from a paper feeding cassette is nipped between two rollers is sent toward the secondary transfer nip portion at just the time when the recording medium 60 can be superimposed on the four-color superimposed toner image. The four-color superimposed toner image on the intermediate transfer belt 58 is influenced by a secondary transfer bias from a paper transfer bias roller 63 in the secondary transfer nip portion and is then secondarily transferred onto the recording medium 60 at a time. By the secondary transfer, a full-color image can be formed on the recording medium 60.

The recording medium 60 with the full-color image formed thereon is sent to a paper conveying belt 64 by a transfer belt 62. The paper conveying belt 64 sends the recording medium 60 received from the transfer unit into a fixing device 65. The fixing device 65 conveys the sent recording medium 60 with nipping the recording medium 60 in between fixing nips that are formed by a contact of a heating roller with a backup roller. The full-color image on the recording medium 60 is affected by heat applied from the heating roller and an applied pressure within the fixing nips and is then fixed on the recording medium 60 (transfer sheet).

Note that a bias for adsorbing the recording medium 60 is applied to the transfer belt 62 and the paper conveying belt 64, respectively, although they are not illustrated in the figure. Further, the intermediate transfer unit is provided with a paper charge eliminating charger which eliminates the charge on the recording medium 60 and three belt charge eliminating chargers to eliminate a residual charge on respective belts (an intermediate transfer belt 58, a transfer belt 62 and a conveying belt 64). Further, the intermediate transfer unit is equipped with a belt cleaning unit having a similar configuration to that of the drum cleaning unit 55. A transfer residual toner remaining on the intermediate transfer belt 58 is removed by the drum cleaning unit 55.

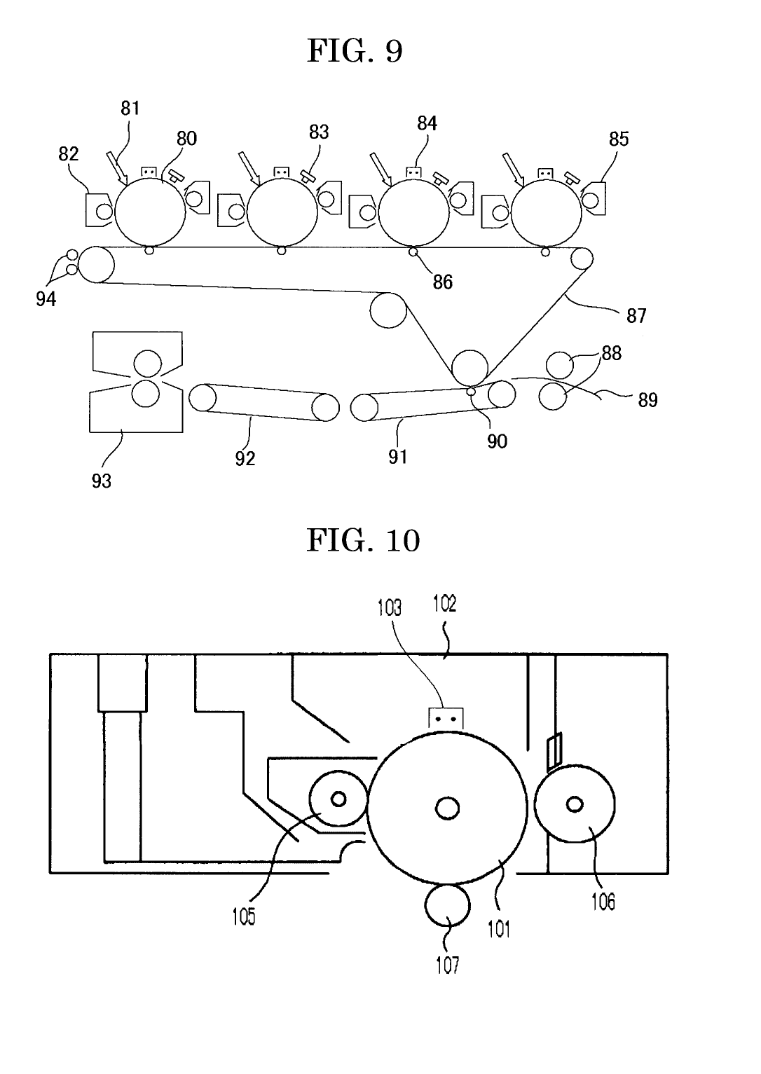

Next, FIG. 9 is a schematic view showing another embodiment of the image forming apparatus of the present invention. The image forming apparatus is a so-called tandem type printer and is provided with photoconductor drums 80Y, 80M, 80C and 8OBk respectively used for four color toners of cyan (C), magenta (M), yellow (Y) and black (K), not sharing the photoconductor 56 with each of the four colors, as can be seen in FIG. 8. The image forming apparatus is further equipped with drum cleaning units 85, charge elimination lamps 83 and charging chargers 84 respectively provided for each of four colors of cyan (C), magenta (M), yellow (Y) and black (K).

In the tandem type printer, latent electrostatic images of four colors can be formed in parallel and can be developed in parallel, and thus the tandem type printer allows for achieving a much higher image forming rate than that of the revolver type printer.

The image forming units in the image forming apparatus explained as above may be incorporated into a copier, a facsimile or a printer or may be incorporated in a form of a process cartridge, which will be hereinafter explained, into an image forming apparatus.

### (Process Cartridge)

A process cartridge according to the present invention is provided with an electrophotographic photoconductor and at least one unit selected from a charging unit, an exposing unit, a developing unit, a transfer unit, a cleaning unit and a charge eliminating unit, and is used in the image forming apparatus of the present invention.

FIG. 10 is a schematic view showing the configuration of an image forming apparatus equipped with the cartridge of the present invention. A photoconductor 101 has at least a photosensitive layer on a substrate, and the outermost surface layer contains a compound represented by any one of General Formulas (1) and (2) and a filler. A reference numeral 103 denotes a charging unit, a reference numeral 105 denotes a developing unit, a reference numeral 107 denotes a transfer unit, and a reference numeral 106 denotes a cleaning unit.

In the present invention, among the constitutional elements including the photoconductor 101, the charging unit 103, the developing unit 105 and the cleaning unit 106, at least the photoconductor 101 and the developing unit 105 are integrally combined into one unit of process cartridge, and the process cartridge can be detachably mounted to the main body of an image forming apparatus such as a copier and a printer.

### EXAMPLES

Hereafter, the present invention will be further described in detail referring to specific Examples, however, the present invention is not limited to the disclosed Examples.

### Production Example 1

### —Preparation of Electrophotographic Photoconductor 1—

Over the surface of an aluminum cylinder, an undercoat layer coating solution, a charge generating layer coating solution and a charge transporting layer coating solution each having the following composition were applied in this order by immersion coating, the applied coating solutions were respectively dried to thereby form an undercoat layer having a thickness of 3.5 μm, a charge generating layer having a thickness of 0.2 μm and a charge transporting layer having a thickness of 22 μm, respectively.

### <Composition of Undercoat Layer Coating Solution>

| | |
|---|---|
| Titanium dioxide powder | 400 parts by mass |
| Melamine resin | 65 parts by mass |
| Alkyd resin | 120 parts by mass |
| 2-butanone | 400 parts by mass |

### <Composition of Charge Generating Layer Coating Solution>

| | | |
|---|---|---|
| Bisazo pigment represented by the following structural | 12 | parts by mass |
| formula | | |

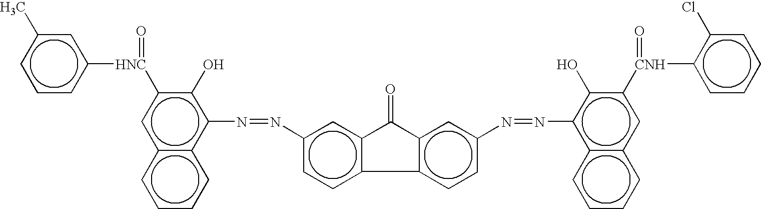

| | | |
|---|---|---|
| Polyvinyl butyral | 5 | parts by mass |
| 2-butanone | 200 | parts by mass |
| Cyclohexanone | 400 | parts by mass |

### <Composition of Charge Transporting Layer Coating Solution>

| | | |
|---|---|---|
| Polycarbonate (Z POLICA, manufactured by | 10 | parts by mass |
| Teijin Chemicals, Ltd.) | | |
| Charge transporting material represented | 10 | parts by mass |
| by the following structural formula | | |

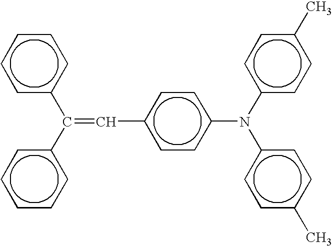

| | | |
|---|---|---|
| Tetrahydrofuran | 100 | parts by mass |

Next, on the charge transporting layer, a protective layer coating solution having the following composition was applied by spray coating to thereby form a protective layer having a thickness of 5.0 μm. With the treatments stated above, an electrophotographic photoconductor 1 was prepared.

### <Composition of Protective Layer Coating Solution>

| | | |
|---|---|---|
| Alumina filler (average primary particle diameter: | 2 | parts by mass |
| 0.3 μm, SUMICORANDOM AA-03, | | |
| manufactured by | | |
| Sumitomo Chemical Co., Ltd.) | | |
| Unsaturated polycarboxylic | 0.02 | parts by mass |
| polymer solution (acidic value: 180 mgKOH/g, | | |
| solid content: 50% by mass, BYK-P104 | | |
| manufactured by BYK Chemie Co.) | | |
| Exemplified Compound 9 represented by the | 0.6 | parts by mass |
| following structural formula | | |

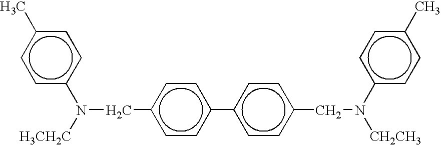

| | | |
|---|---|---|
| Charge transporting material represented by the | 3 | parts by mass |
| following structural formula | | |

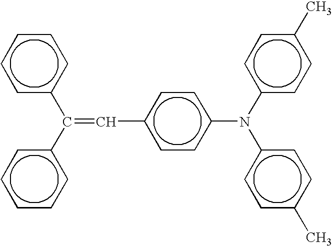

| | | |
|---|---|---|
| Polycarbonate (Z POLICA, manufactured by | 5 | parts by mass |
| Teijin Chemicals, Ltd.) | | |
| Tetrahydrofuran | 250 | parts by mass |
| Cyclohexanone | 70 | parts by mass |

### Production Example 2

### —Preparation of Electrophotographic Photoconductor 2—

An electrophotographic photoconductor 2 was prepared in the same manner as in Production Example 1 except that the protective coating solution was changed to a protective coating solution having the following composition.

### <Composition of Protective Layer Coating Solution>

| | | |
|---|---|---|
| Alumina filler (average primary particle diameter: | 2 | parts by mass |
| 0.3 μm, SUMICORANDOM AA-03, | | |
| manufactured by | | |
| Sumitomo Chemical Co., Ltd.) | | |
| Unsaturated polycarboxylic | 0.02 | parts by mass |
| polymer solution (acidic value: 180 mgKOH/g, | | |
| solid content: 50% by mass, BYK-P104 | | |
| manufactured by BYK Chemie Co.) | | |
| Exemplified Compound 2 represented by the | 1.8 | parts by mass |
| following structural formula | | |

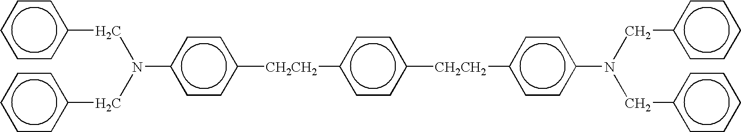

| | | |
|---|---|---|
| Charge transporting material represented by the | 1.8 | parts by mass |
| following structural formula | | |

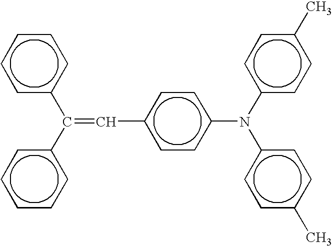

| | | |
|---|---|---|
| Polycarbonate (Z POLICA, manufactured by | 5 | parts by mass |
| Teijin Chemicals, Ltd.) | | |
| Tetrahydrofuran | 250 | parts by mass |
| Cyclohexanone | 70 | parts by mass |

### Production Example 3

### —Preparation of Electrophotographic Photoconductor 3—

An electrophotographic photoconductor 3 was prepared in the same manner as in Production Example 1 except that the protective layer coating solution was changed to a protective layer coating solution having the following composition.

### <Composition of Protective Layer Coating Solution>

| | | |
|---|---|---|
| Alumina filler (average primary particle diameter: | 1 | part by mass |
| 0.3 μm, SUMICORANDOM AA-03, | | |
| manufactured by | | |
| Sumitomo Chemical Co., Ltd.) | | |
| Unsaturated polycarboxylic | 0.01 | parts by mass |
| polymer solution (acidic value: 180 mgKOH/g, | | |
| solid content: 50% by mass, BYK-P104 | | |
| manufactured by BYK Chemie Co.) | | |
| Exemplified Compound 9 represented by the | 0.6 | parts by mass |
| following structural formula | | |

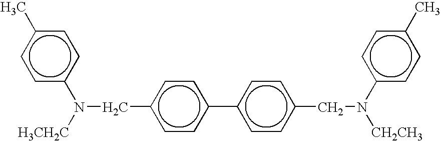

| | | |
|---|---|---|
| Charge transporting material represented by the | 3 | parts by mass |
| following structural formula | | |

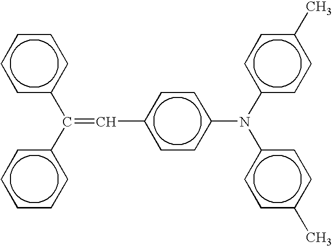

| | | |
|---|---|---|
| Polycarbonate (Z POLICA, manufactured by | 5 | parts by mass |
| Teijin Chemicals, Ltd.) | | |
| Tetrahydrofuran | 250 | parts by mass |
| Cyclohexanone | 70 | parts by mass |

### Production Example 4

### —Preparation of Electrophotographic Photoconductor 4—

An electrophotographic photoconductor 4 was prepared in the same manner as in Production Example 1 except that the protective layer coating solution was changed to a protective layer coating solution having the following composition.

### <Composition of Protective Layer Coating Solution>

| | | |
|---|---|---|
| Alumina filler (average primary particle diameter: | 3 | parts by mass |
| 0.3 μm, SUMICORANDOM AA-03, | | |
| manufactured by | | |
| Sumitomo Chemical Co., Ltd.) | | |
| Unsaturated polycarboxylic | 0.03 | parts by mass |
| polymer solution (acidic value: 180 mgKOH/g, | | |
| solid content: 50% by mass, BYK-P104 | | |
| manufactured by BYK Chemie Co.) | | |
| Charge transporting material of | 0.9 | parts by mass |
| Exemplified Compound 9 represented by the | | |
| following structural formula | | |

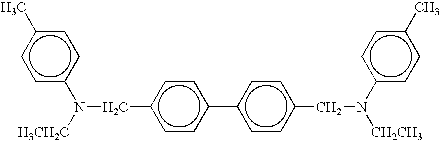

| | | |
|---|---|---|
| Charge transporting material represented by the | 4 | parts by mass |
| following structural formula | | |

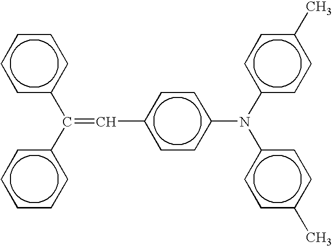

| | | |
|---|---|---|
| Polycarbonate (Z POLICA, manufactured by | 3 | parts by mass |
| Teijin Chemicals, Ltd.) | | |
| Tetrahydrofuran | 250 | parts by mass |
| Cyclohexanone | 70 | parts by mass |

### Production Example 5

### —Preparation of Electrophotographic Photoconductor 5—

An electrophotographic photoconductor 5 was prepared in the same manner as in Production Example 1 except that the protective layer coating solution was changed to a protective layer coating solution having the following composition.

### <Composition of Protective Layer Coating Solution>

| | | |
|---|---|---|
| Alumina filler (average primary particle diameter: | 3 | parts by mass |
| 0.5 μm, SUMICORANDOM AA-05, | | |
| manufactured by | | |
| Sumitomo Chemical Co., Ltd.) | | |
| Unsaturated polycarboxylic | 0.02 | parts by mass |
| polymer solution (acidic value: 180 mgKOH/g, | | |
| solid content: 50% by mass, BYK-P104 | | |
| manufactured by BYK Chemie Co.) | | |
| Charge transporting material of | 0.9 | parts by mass |
| Exemplified Compound 9 represented by the | | |
| following structural formula | | |

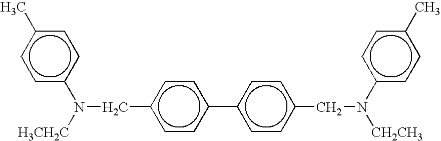

| | | |
|---|---|---|
| Charge transporting material represented by the | 4 | parts by mass |
| following structural formula | | |

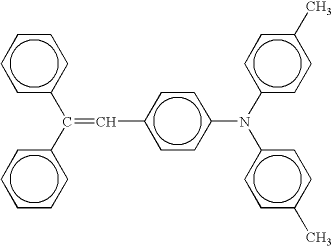

| | | |
|---|---|---|
| Polycarbonate (Z POLICA, manufactured by | 3 | parts by mass |
| Teijin Chemicals, Ltd.) | | |
| Tetrahydrofuran | 250 | parts by mass |
| Cyclohexanone | 70 | parts by mass |

### Production Example 6

### —Preparation of Electrophotographic Photoconductor 6—

An electrophotographic photoconductor 6 was prepared in the same manner as in Production Example 1 except that the protective layer coating solution was changed to a protective layer coating solution having the following composition.

### <Composition of Protective Layer Coating Solution>

| | | |
|---|---|---|
| Alumina filler (average primary particle diameter: | 2 | parts by mass |
| 0.3 μm, SUMICORANDOM AA-03, | | |
| manufactured by | | |
| Sumitomo Chemical Co., Ltd.) | | |
| Unsaturated polycarboxylic | 0.02 | parts by mass |
| polymer solution (acidic value: 180 mgKOH/g, | | |
| solid content: 50% by mass, BYK-P104 | | |
| manufactured by BYK Chemie Co.) | | |
| Charge transporting material represented by the | 4 | parts by mass |
| following structural formula | | |

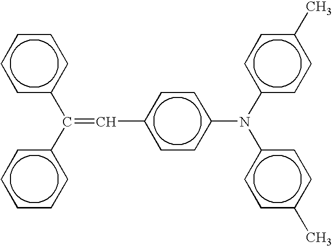

| | | |
|---|---|---|
| Polycarbonate (Z POLICA, manufactured by | 6 | parts by mass |
| Teijin Chemicals, Ltd.) | | |
| Tetrahydrofuran | 220 | parts by mass |
| Cyclohexanone | 80 | parts by mass |

Thereafter, charge eliminating units 1 to 4 as described below were prepared.

### <Charge Eliminating Unit 1>

As a charge eliminating unit, an LED array for emitting a wavelength of 660 nm was used, the energy of the charge eliminating light to be applied to the electrophotographic photoconductor was set to 0.9 μJ/cm², and the voltage of the LED array was controlled so as to emit the light during rotation of the electrophotographic photoconductor. Note that the energy of the charge eliminating light of 0.9 μJ/cm² corresponds to 5 times to 7 times a half exposure dose when the prepared electrophotographic photoconductor is charged to −800V and is such a sufficient exposure energy that optical attenuation properties of the electrophotographic photoconductor can be saturated.

### <Charge Eliminating Unit 2>

As a charge eliminating unit, an LED array for emitting a wavelength of 660 nm was used, the energy of the charge eliminating light to be applied to the electrophotographic photoconductor during rotation of the electrophotographic photoconductor in the successive image forming operation was set to 0.45 μJ/cm², and the voltage of the LED array was controlled so that the energy of the charge eliminating light for a time length of one rotation of the electrophotographic photoconductor after the end of the job but just before the stoppage of rotation thereof was 0.9 μJ/cm².

### <Charge Eliminating Unit 3>

As a charge eliminating unit, an LED array for emitting a wavelength of 660 nm was used, the energy of the charge eliminating light to be applied to the electrophotographic photoconductor during rotation of the electrophotographic photoconductor in the successive image forming operation was set to 0.225 μJ/cm², and the voltage of the LED array was controlled so that the energy of the charge eliminating light for a time length of one rotation of the electrophotographic photoconductor after the end of the job but just before the stoppage of rotation thereof was 0.9 μJ/cm².

### <Charge Eliminating Unit 4>

As a charge eliminating unit, an LED array for emitting a wavelength of 660 nm was used, the energy of the charge eliminating light to be applied to the electrophotographic photoconductor during rotation of the electrophotographic photoconductor in the successive image forming operation was set to 0.60 μJ/cm², and the voltage of the LED array was controlled so that the energy of the charge eliminating light for a time length of one rotation of the electrophotographic photoconductor after the end of the job but just before the stoppage of rotation thereof was 0.9 μJ/cm².

### Examples 1 to 9 and Comparative Examples 1 to 6

### —Formation of Image—

Next, in a digital image forming apparatus (IMAGIO MF2200 remodeled machine, manufactured by Ricoh Company Ltd.) in which a corona charger (scorotoron type) was used for charging the surface of the electrophotographic photoconductor and a laser diode (LD) emitting 655 nm light was used as a light source for image exposure, a combination of the prepared photoconductor and the charge eliminating unit as shown in Tables 1-A and 1-B was used and the dark space potential was set to 800 (−V). Subsequently, 100,000 sheets in total of A4 size lateral were printed out under the condition of 5 sheets per one job (5 sheets/job) and 10 sec-job intervals. A potential at a bright area and an abrasion loss in the initial stage of the printing and after printing 100,000 sheets, image quality of the image during printing (image blur and incidental image, etc.) were evaluated as follows. Tables 1-A and 1-B show the evaluation results.

### <Evaluation of Image Quality and Amount of Potential Change at Bright Area>

An image print output after the repetitive output test of 100,000 sheets was visually checked to evaluate the image quality (image blur and incidental image).

Further, a potential at a bright area in the initial stage of the printing and a potential at the bright area after the repetitive output test were measured. The amount of potential change was calculated.

### <Abrasion Loss of Electrophotographic Photoconductor>

An abrasion loss of the photoconductor was determined by deducting the thickness of the photoconductor after the repetitive output test of 100,000 sheets from the thickness of the photoconductor in the initial stage of the printing. The thickness of the photoconductor was measured using an eddy-current film thickness meter.

TABLE 1-A

| | | | Potential at bright | | | | |
|---|---|---|---|---|---|---|---|
| | | | area(−V) | | | | |
| | | | In initial | After | | | |
| | | Charge | stage | printing | Abrasion | Image quality | |
| | Photo- | eliminating | of | 100,000 | loss | | Incidental |
| | conductor | unit | printing | sheets | (μm) | Image blur | image |
| Ex. 1 | 1 | 2 | 81 | 175 | 1.07 | Favorable | Favorable |
| | | | | | | result | result |
| Ex. 2 | 1 | 3 | 77 | 136 | 0.88 | Favorable | Favorable |
| | | | | | | result | result |
| Ex. 3 | 1 | 4 | 84 | 202 | 1.12 | Favorable | Favorable |
| | | | | | | result | result |
| Ex. 4 | 2 | 2 | 77 | 166 | 1.06 | Favorable | Favorable |
| | | | | | | result | result |
| Ex. 5 | 2 | 3 | 80 | 145 | 0.94 | Favorable | Extremely |
| | | | | | | result | minor |
| | | | | | | | incidental |
| | | | | | | | images |
| | | | | | | | occurred |
| | | | | | | | after printing |
| | | | | | | | out 90,000 |
| | | | | | | | sheets |
| Ex. 6 | 2 | 4 | 81 | 202 | 0.98 | Favorable | Favorable |
| | | | | | | result | result |
| Ex. 7 | 3 | 2 | 72 | 166 | 1.17 | Favorable | Favorable |
| | | | | | | result | result |
| Ex. 8 | 4 | 2 | 85 | 171 | 0.61 | Favorable | Favorable |
| | | | | | | result | result |
| Ex. 9 | 5 | 2 | 75 | 170 | 0.46 | Favorable | Favorable |
| | | | | | | result | result |

TABLE 1-B

| | | | Potential at bright | | | | |
|---|---|---|---|---|---|---|---|
| | | | area | | | | |
| | | | (−V) | | | | |
| | | | In initial | After | | | |
| | | Charge | stage | printing | Abrasion | Image quality | |
| | Photo- | eliminating | of | 100,000 | loss | | Incidental |
| | conductor | unit | printing | sheets | (μm) | Image blur | image |
| Com. | 6 | 1 | 80 | 258 | 1.13 | Resolution | Favorable |
| Ex. 1 | | | | | | reduced | result |
| | | | | | | after | |
| | | | | | | printing out | |
| | | | | | | 10,000 | |
| | | | | | | sheets | |
| Com. | 6 | 2 | 76 | 172 | 0.95 | Resolution | Incidental |
| Ex. 2 | | | | | | reduced | images |
| | | | | | | after | occurred |
| | | | | | | printing out | after |
| | | | | | | 30,000 | printing |
| | | | | | | sheets | out 70,000 |
| | | | | | | | sheets |
| Com. | 6 | 3 | 76 | 145 | 1.09 | Resolution | Incidental |
| Ex. 3 | | | | | | reduced | images |
| | | | | | | after | occurred |
| | | | | | | printing out | after |
| | | | | | | 30,000 | printing |
| | | | | | | sheets | out 10,000 |
| | | | | | | | sheets |
| Com. | 6 | 4 | 83 | 201 | 1.11 | Resolution | Incidental |
| Ex. 4 | | | | | | reduced | images |
| | | | | | | after | occurred |
| | | | | | | printing out | after |
| | | | | | | 20,000 | printing |
| | | | | | | sheets | out 80,000 |
| | | | | | | | sheets |
| Com. | 1 | 1 | 77 | 257 | 1.14 | Favorable | Favorable |
| Ex. 5 | | | | | | result | result |
| Com. | 2 | 2 | 76 | 245 | 1.12 | Favorable | Favorable |
| Ex. 6 | | | | | | result | result |

The results shown in Tables 1-A and 1-B demonstrated that it was possible to largely reduce an increase in potential at a bright area of the electrophotographic photoconductor containing a filler in the outermost surface layer thereof by eliminating a residual charge on the electrophotographic photoconductor with a charge eliminating exposure dose B for a time length of at least one rotation or more of the electrophotographic photoconductor after the electrophotographic photoconductor had gone through an image formation process but just before the stoppage of rotation of the electrophotographic photoconductor and by setting a charge eliminating exposure dose A that was used to irradiate the electrophotographic photoconductor during image forming operation to a lower value than the charge eliminating exposure dose B and then irradiating the electrophotographic photoconductor in working condition with the charge eliminating exposure dose A. It was also verified that when using an image forming apparatus using a photoconductor containing a compound represented by any one of General Formulas (1) and (2) in the outermost surface layer thereof, it was possible to prevent occurrence of image blur and incidental images and to obtain a high-quality image with stability.

What is claimed is:

1. An image forming apparatus, comprising:
an electrophotographic photoconductor,
a corona discharge type charging unit configured to charge the surface of the electrophotographic photoconductor in a non-contact manner,
an exposing unit configured to expose the charged electrophotographic photoconductor surface to form a latent electrostatic image,
a developing unit configured to develop the latent electrostatic image using a toner to form a visible image,
a transfer unit configured to transfer the visible image onto a recording medium, and
a charge eliminating unit configured to eliminate a residual charge on the electrophotographic photoconductor by irradiating the electrophotographic photoconductor with light,
wherein the outermost surface layer of the electrophotographic photoconductor comprises at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation, 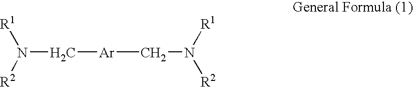
where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group, 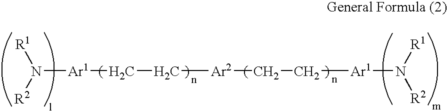
where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.

2. The image forming apparatus according to claim 1, wherein a charge eliminating exposure dose A of the charge eliminating unit used to irradiate the electrophotographic photoconductor during image forming operation is set to a lower value than a charge eliminating exposure dose B of the charge eliminating unit that is used to irradiate the electrophotographic photoconductor for a time length of at least one rotation or more of the electrophotographic photoconductor just before the stoppage of rotation thereof.

3. The image forming apparatus according to claim 2, wherein the charge eliminating exposure dose A is ¼ to ⅔ of the charge eliminating exposure dose B.

4. The image forming apparatus according to claim 1, wherein the filler comprises at least one selected from metal oxides.

5. The image forming apparatus according to claim 1, wherein the filler has an average primary particle diameter of 0.01 μm to 1.0 μm.

6. The image forming apparatus according to claim 1, wherein the content of the filler in the outermost surface layer of the electrophotographic photoconductor is 5% by mass to 50% by mass.

7. The image forming apparatus according to claim 1, wherein the outermost surface layer of the electrophotographic photoconductor comprises an organic compound having an acidic value of 10 mgKOH/g to 700 mgKOH/g.

8. The image forming apparatus according to claim 1, wherein the electrophotographic photoconductor comprises a substrate, a photosensitive layer and a protective layer formed in this order on the substrate, and the protective layer constitutes the outermost surface layer.

9. The image forming apparatus according to claim 1, wherein the exposing unit is any one of a laser diode (LD) and a light-emitting diode (LED), and a latent electrostatic image is digitally written on the electrophotographic photoconductor using the exposing unit.

10. The image forming apparatus according to claim 1, wherein visual images in a plurality of colors are sequentially superimposed on the electrophotographic photoconductor to form a color image.

11. The image forming apparatus according to claim 1, comprising a plurality of electrophotographic photoconductors, wherein monochrome visual images developed on the respective electrophotographic photoconductors are sequentially superimposed to form a color image.

12. The image forming apparatus according to claim 1, further comprising an intermediate transfer unit configured to primarily transfer a visual image developed on the electrophotographic photoconductor to an intermediate transfer member and then secondarily transfer the visual image on the intermediate transfer member onto a recording medium, wherein visual images in a plurality of colors are sequentially superimposed on the intermediate transfer member to form a color image, and the color image is secondarily transferred onto the recording medium at a time.

13. An image forming method, comprising:
charging the surface of an electrophotographic photoconductor with a corona discharge type charging unit in a non-contact manner,
exposing the charged electrophotographic photoconductor surface to form a latent electrostatic image,
developing the latent electrostatic image using a toner to form a visible image,
transferring the visible image onto a recording medium, and
eliminating a residual charge on the electrophotographic photoconductor by irradiating the electrophotographic photoconductor with light,
wherein the outermost surface layer of the electrophotographic photoconductor comprises at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation, 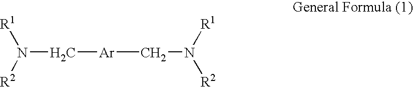
where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group, 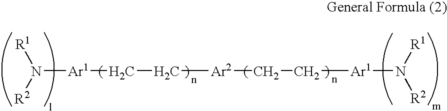
where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.

14. A process cartridge, comprising:
an electrophotographic photoconductor, and
at least one selected from a charging unit, an exposing unit, a developing unit, a transfer unit, a cleaning unit and a charge eliminating unit,
wherein the process cartridge is detachably mounted to the main body of an image forming apparatus,
wherein the image forming apparatus comprises the electrophotographic photoconductor, the corona discharge type charging unit configured to charge the surface of the electrophotographic photoconductor in a non-contact manner, the exposing unit configured to expose the charged electrophotographic photoconductor surface to form a latent electrostatic image, the developing unit configured to develop the latent electrostatic image using a toner to form a visible image, the transfer unit configured to transfer the visible image onto a recording medium, and a charge eliminating unit configured to eliminate a residual charge on the electrophotographic photoconductor by irradiating the electrophotographic photoconductor with light,
wherein the outermost surface layer of the electrophotographic photoconductor comprises at least a filler and a compound represented by any one of the following General Formulas (1) and (2), and the exposure dose of the charge eliminating unit is controlled at at least two stages during a time from the start of an image forming operation, i.e., from when the electrophotographic photoconductor is driven to rotate, to the end of the image forming operation, 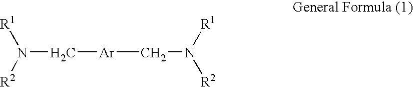
where, R¹ and R² may be the same to each other or different from each other, respectively represent any one of an alkyl group that may have a substituent group and an aryl group that may have a substituent group, at least one of the R¹ and R² is an aryl group that may have a substituent group, the R¹ and R² may be combined to each other to form a heterocyclic ring containing a nitrogen atom, and the heterocyclic ring may be further substituted by a substituent group; and Ar represents an aryl group that may have a substituent group, 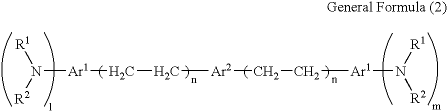
where, R¹ and R² may be the same to each other or different from each other, respectively represent an unsubstituted alkyl group or an alkyl group substituted by an aromatic hydrocarbon group, the R¹ and R² may be combined to each other to form a heterocyclic ring containing a nitrogen atom, and the heterocyclic ring may be further substituted by a substituent group; Ar¹ and Ar² respectively represent an aryl group that may have a substituent group; “l” and “m” respectively represent an integer of 0 to 3, and both of the “l” and “m” cannot be an integer of zero at the same time; and “n” is an integer of 1 or 2.
